(19) United States
(12) Patent Application Publication
(10) Pub. No.: US 2018/0124839 A1
(43) Pub. Date: May 3, 2018

(54) OPTICAL ELEMENT FOR HEAT COLLECTION

(71) Applicant: Donald Bennett Hilliard, Tucson, AZ (US)

(72) Inventor: Donald Bennett Hilliard, Tucson, AZ (US)

(21) Appl. No.: 15/854,823

(22) Filed: Dec. 27, 2017

Related U.S. Application Data
(63) Continuation of application No. 15/544,668, filed on Jul. 19, 2017.
Application No. 15/544,668 is a continuation-in-part of application No. PCT/US2011/000966, filed on Mar. 31, 2010.
Application No. PCT/US2011/000966 is a continuation-in-part of application No. 13/261,526, filed on Jan. 2, 2014, now abandoned.
(60) Provisional application No. 62/498,505, filed on Dec. 27, 2016.

(51) Int. Cl. H04W 76/00; H04W 48/00; H04W 8/26; H04W 8/24

(52) U.S. Cl. CPC H04W 76/007; H04W 48/17; H04W 8/26; H04W 76/02; H04W 8/24; H04W 76/062

(57) ABSTRACT

The disclosed invention relates to an optical element preferably utilized for concentrating solar heat radiation, and more particularly, high-concentration, reflective concentrators that are constructed from discrete conical concentrators utilizing flexible high-reflectance layers that are produced by roll-to-roll manufacturing. In its first preferred embodiment, the disclosed optical element preferably comprises a quasi-parabolic, multi-frustum, concentration optic.

### FIELD OF THE INVENTION

The present invention relates primarily to concentrating-mirror, optical elements under USPC Class 359, particularly 359:838; and also USPC Class 129:569; USPC Class 129:684 for concentrating solar heat. The present application claims the benefit of U.S. Provisional Patent Appln. 62/498,505, filed Dec. 27, 2016. The present application is also a continuation-in-part of application Ser. No. 13/261,486, which is the National Stage of International Application No. PCT/US2011/000050, filed Jan. 11, 2011. The present application is a continuation-in-part of application Ser. No. 14/544,688, filed Feb. 2, 2015. The present application is a continuation-in-part of application Ser. No. 13/261,526, which is the National Stage of International Application No. PCT/US2011/000966, filed May 26, 2011. All above applications are, in their entirety, incorporated herein by reference.

### BACKGROUND OF THE INVENTION

A primary obstacle in the commercialization of solar energy conversion devices comprises the need to simultaneously minimize manufacturing costs while maintaining physical tolerances and durability necessary to retain a desired efficiency and device lifetime. In segments of the solar energy industry utilizing a solar concentrator or condenser, the challenge to reduce manufacturing costs is most significant in the solar collector design, as the component generally requiring the greatest materials expense. A crowded array of art has been introduced to address this challenge, including, broadly speaking, such relatively large solar concentrators as linear trough systems and linear Fresnel systems, dish systems including parabolic and compound reflectors.

### SUMMARY OF THE INVENTION

In accordance with the first preferred embodiments, structures and manufacturing methods are embodied, which provide numerous advantages in the manufacture of precise and cost-effective large solar-concentrating optics.

An objective of the present invention is to provide means for constructing conical, right-angle, frustums by way of specific structures and processes that provide high-throughput, high-precision, and low materials usage. In a preferred embodiment, both advantageous manufacturing paths and advantageous dimensional stability is realized through specific radial symmetry, wherein structural cells of hollow-core media, particularly as a modified honey-comb-type structure, are altered in a specific pre-determined manner so as to provide a repeating angular period, resulting is a specific radial symmetry of the core media. Moreover, the design enables a cellular structure that can be uniquely tailored structurally, through the unique symmetry and approach, for maximum strength-to-weight ratio specifically for the preferred right-conical, frustum-shaped articles, wherein the disclosed cellular media can be further optimized for specific circumstances (e.g., wind-loads, axial loads, base-loads, compressive loads, thermal loads and thermal stability, etc).

Such advantages are achieved, in part, by means of removing the characteristic attribute of repeating spatially identical structural components in the frustum structure in favor of utilizing distinct modular processes that each provide a distinct and concentric corrugation layer having its own distinct spatial attributes. Also, it is found that implementing certain types of angular symmetry are beneficial in ways that outweigh the added complexity embodied in the inventive manufacturing process.

Accordingly, another objective of the present invention is to provide a structure that induces a minimum of asymmetric thermal expansion during operation, resulting in maintenance of precision optical alignment. A preferred means for achieving this objective has been found to construct separate corrugating means and corrugation waveforms for each separate layer

A primary advantage of the present invention is extremely high-throughput manufacturing of large concentration optics for solar harvesting in the area of concentrated solar energy, through first manufacturing an embodied preform structure that is formed from planar flexible media, wherein the media is first pre-patterned with an array of slits that allow fast parting of the preform into a multiple of solar concentrating articles. Since the disclosed solar-concentration structures are composed, in the preferred embodiment, of only aluminum and a common organic resin, such as silicone, phenolic, or an acetate, and because the embodied large optic is exceedingly light, the cost of consumables required in its manufacture are accordingly minimized.

A primary advantage of the concentrator design herein is in its ability to allow precision optical resolution and concentration factors equivalent to parabolic dish systems, without the expenses associated with making actual aspherical surfaces. The parabolic and other aspheric concentrators of the prior art that require quadratically derived 3D surfaces, or surfaces that possess curvatures in more than one axis, typically require both proprietary molding/shaping processes for producing panels that possess these aspheric properties. Instead, the present embodiments realize the concentration capabilities of a high-concentration, tracking parabolic dish, but through much more effective use of roll-to-roll-produced reflecting sheet relative to its use in lower-concentration trough systems and segmented parabolic dishes.

In one preferred embodiment, high-throughput methods and structures utilize pulsed fiber lasers in the nanosecond pulse regime, are utilized so as to provide selective removal of a tabbing structure in a pre-patterned preform, so that the preform is quickly separated into a multitude of right-conical frustum structures comprising core media for the embodied solar concentrator. Parting of the preform is advantageously executed through utilization of particular methods of laser cutting, particular in larger focal length and remote laser cutting (RLC) wherein the large focal lengths allow access to a great many interconnection structures without mechanical translation of a laser scan head.

Another advantage of the present invention is realized through a specific preform winding processes, including corrugation and laser pre-patterning stages, that enable fast and precise manufacture of preforms that are determined by precise, reproducible angular and spatial relationships, due in part to the described incremental variations of corrugation structure. In the inventive process, a dual-stage cutting process involves pre-determined, patterned cut processes that take place both before and after winding the preform, wherein this dual-stage process results in a preform parting operation that is limited only by the combined cutting speed of tandem lasers, and the subsequent mechanical removal of the parted frustum core structure.

A basic flow chart for this process of the preferred embodiments includes the following steps:

a.) winding a multilayer inner edge-surface structure onto a roughly cylindrical inner spool-chuck, the multi-layer comprised of aluminum foil interleaved with an organic resin;
b.) winding a first layer of corrugated aluminum foil having a first spatial profile, adhering the first corrugated foil with organic-base adhesive, the first corrugated foil pre-patterned with tabbed separation pattern;
c.) winding a first layer of un-corrugated aluminum foil, the first layer of un-corrugated foil pre-patterned with tabbed separation pattern, adhering the first un-corrugated foil with organic-base adhesive;
d.) winding a second layer of corrugated aluminum foil having a second spatial profile, adhering the second corrugated foil with organic-base adhesive, the second corrugated foil pre-patterned with tabbed separation pattern;
e.) winding a second layer of un-corrugated aluminum foil, the second layer of un-corrugated foil pre-patterned with tabbed separation pattern, adhering the second un-corrugated foil with organic-base adhesive;
f.) repeating additional process of steps (d.) and (e.) to produce total number of desired pairs of corrugated and un-corrugated foil, wherein the spatial profile is altered in each successive pair, such that a radial symmetry is generated and a desired cross-sectional pattern is obtained;
g.) winding a multilayer outer edge-surface structure onto the corrugated assembly, the multi-layer comprised of aluminum foil interleaved with an organic resin, so that a cylindrical preform structure is formed; and,
h.) separating preform into plurality of annular conical frustum cores by removing tab structures.

In yet another advantage of the present invention, specific segmentation of the cladding layers of the sandwiched honey-comb-like, frustum-shaped core media is disclosed, wherein specific layout and seam structures are disclosed for high-efficiency manufacturing.

In yet another advantage of the present invention, an edge-surface structure is disclosed, which is particularly advantageous for providing high strength-to-weight ratio, high rigidity, and high precision, while being completely manufactured in the same fabrication process as that of the disclosed preform.

In accordance with a preferred embodiment, a compound conical concentrator comprising a solar concentrating reflector is disclosed. In a first embodiment, a high-reflectivity (e.g., >90% reflectivity in visible spectrum) conical frustum is disclosed, comprising a conical frustum structure comprising a double-layered structure wherein parallel outer layers are separated by an integral, lightweight, networked structure comprising the mesh structure of a hollow core, preferably comprising a corrugated-metal-type core. In a sectional profile taken through a plane containing the frustum's central axis, the frustum has opposite parallel surfaces in the form of a parallelogram; the double-layer structure comprising opposing inner and outer surfaces of the conic frustum, the first surface and second surface roughly parallel, the inner surface preferably having an optical reflectivity of at least 90%, preferably with a divergence of inner surface of preferably less than 1% from the associated, theoretically ideal frustum surface.

The inner core of the embodied frustum preferably comprises a plurality of concentric and parallel ring-shaped surfaces extending between inner frustum surface and outer frustum surface, the ring-shaped surfaces at a substantially uniform acute angle adjoining inner and outer frustum surfaces, wherein separated ring-shaped corrugation layer of the honeycomb-type material are preferably sandwiched within the spaces formed between these concentric rings and between the inner and outer surfaces of the embodied frustum. The core mesh material is preferably comprising an aluminum corrugated-metal structure. The top and bottom preferably parallel, edge-surfaces of the embodied stackable conic frustums comprise alignment surfaces for aligning and stacking a series of adjacent frustums in a coaxial arrangement.

An objective of the presently embodied solar concentrating reflector is accordingly to provide an assembly of conical frustums that each have a sectional profile, as taken through a sectioning plane that contains the frustum's optical axis, which comprises roughly a parallelogram, and wherein external surface of such a frustum accordingly comprise parallel inner and outer frustum surfaces as well as two parallel edge-surfaces, wherein edge surfaces are surface adjoining the inner and outer surfaces of the frustum at its top and bottom.

It is accordingly preferred, in the telescoping embodiments of multi-frustum concentrators, that the individual conical frustums of the present invention are constructed so that upper and lower edge-surfaces of the frustum structures are terminated as cylindrical surfaces having central axis coincident with the optical axis, so the reflective, inwardly facing frustum surface and outer-facing frustum surface are interconnected and terminated at both upper edge-surface and lower edge-surface by these adjoining cylindrical surfaces. Thus, an advantage of the presently embodied solar concentrating reflector is in the realization of a telescoping compound conical concentrator with inexpensive and replaceable conical concentration frustums.

Another important advantage of the present invention is its use of reflector materials that may be produced by roll-to-roll manufacturing; that is, sheet material that is manufactured in a substantially planar form that can be processed and stored using rolls of sheet material, and through use of such manufacturing processes as roller mills and web processing, wherein various properties including anti-reflection, spectral, diffusion-barrier, encapsulation, etc., may be provided through various organic and inorganic multilayer designs of the prior art. In the preferred embodiments, the reflector material is fashioned into segments that are each provided a shape unique for the purpose of matching the surface area and shape of a conic frustum incorporated in the CCC structure.

Other objects, advantages and novel features of the invention will become apparent from the following description thereof.

### BRIEF DESCRIPTION OF DRAWINGS

FIG. 1(a-b) is a perspective view of a corrugated sheet metal of the prior art, and (b) a perspective cut-away view of an embodiment of the inventive conical concentrator (80) utilizing single sheets of corrugated sheet metal interleaved with non-corrugated sheets, which are viewable in cut-away region (356) of FIG. 1(b) wherein the underlying core material is made viewable, as well as by way of section taken through section lines A and B that are contained by one plane containing central axis (73) of the embodied frustum-shaped reflector (80).

FIG. 2 is a top view of a section of a conical reflector section in one embodiment, viewed along optical axis (73) of the conical concentrator (80) in FIG. 1, having interleaved layers of corrugated sheet metal and non-corrugated sheet metal, which are viewable in cut-away region (356) of FIG. 2 wherein the underlying core material is exposed.

FIG. 3(a-c) is a self-supported frustum of the preferred embodiments comprising (a) a side-sectional view of an alternative annular structure forming the frustum, and (b) a side sectional view of the preferred embodiment of the annular structure forming the frustum, and (c) a perspective view of the self-supported frustum-shaped concentrator in accordance with the preferred embodiments.

FIG. 4(a) is a right-conical, frustum-shaped core structure, of the preferred embodiments;

FIG. 4(b) side-view cross-section of basic structural attributes of the frustum-shaped core structure, in accordance with the preferred embodiments, with section taken through a plane containing central axis (73).

FIG. 5(a) is a top plan-view of a right conical, frustum-shaped core structure of the first preferred embodiments; FIG. 5(b) is a top plan-view of a right conical, frustum-shaped core structure in accordance with an alternative preferred embodiment.

FIG. 6(a) is a top-view comprising a foreshortened segment of the conical, frustum-shaped core structure in accordance with the first preferred embodiment.

FIG. 6(b) is a top-view of a foreshortened segment of the conical, frustum-shaped core structure in accordance with an alternative preferred embodiment, indicating general spatial and angular relationships of the various preferred elements.

FIG. 7(a) is a schematic representation of an alternate exemplary angular period of the radial pattern in FIG. 6(b), in the embodied frustum-shaped core structure of the preferred embodiments; FIG. 7(b) is a preform winding assembly and process of the preferred embodiments

FIG. 8(a) is a multilayer edge-surface structure of the preferred embodiments, showing magnified view of square-outlined caption view (491) in FIG. 6(b); FIG. 8(b) is an exemplary rectangular piece of pre-patterned interfacial foil in its “flattened-state” planar form, in accordance with the preferred embodiments; FIG. 8(c) is an exemplary rectangular piece of pre-patterned corrugation foil in its “flattened-state” planar form, in accordance with the preferred embodiments.

FIG. 9(a) is a side-view of a preform of the preferred embodiments; FIG. 9(b) is a perspective of the preform in a preform parting assembly and process of the preferred embodiments.

FIG. 10 is a magnified caption view of the preform, showing magnified view of square-outlined caption view (562) in FIG. 9(b).

FIG. 11(a) is a repeated angular period of a radial pattern in a frustum-shaped core structure, in an alternative preferred embodiment; FIG. 11(b) is a cladding-layer segment array as laid out for cutting from sheet stock, in accordance with the preferred embodiments; FIG. 11(c) is a segment design for cladding layers of the disclosed frustum structure, comprising segmenting strategy for reflective layers and external layers; FIG. 11(d) is a seam clamp structure of a reflective cladding layer in accordance with the preferred embodiments.

### BEST MODE FOR CARRYING OUT THE INVENTION

In the first preferred embodiment, a conical solar concentrator having frustum-shaped cored media is disclosed, similar to previous core media disclosed by same author in the related applications of this disclosure, wherein specific embodiments provide numerous advantages in precision manufacturing with high throughput.

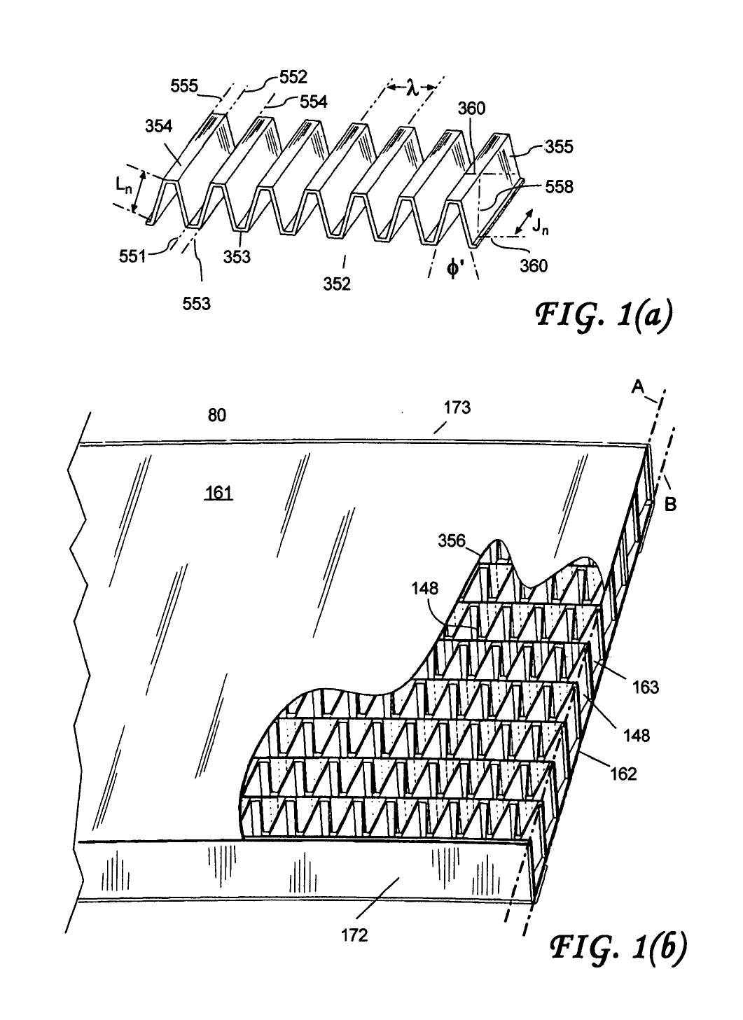

In accordance with the preferred embodiments, a solar concentrator system comprising a conical frustum is disclosed in conjunction with FIGS. 1-11 and in conjunction with the co-pending applications of the present disclosure, which are included herein, in their entirety, by reference. While the embodied multi-frustum concentrator structure of previous disclosures may be realized in a wide variety of concentrators that embody its primary structural elements, it is found in the present invention that certain improved features and manufacturing methods are preferred for low-cost manufacture and efficient energy conversion.

In the present invention, alternative and is some aspects, more economical embodiments to previously disclosed embodiments of a multi-frustum concentrator by same author are disclosed. As in previous embodiments disclosed in the related applications and included herein by reference, a compound conical concentrator is fabricated as a series of separately fabricated conical sections wherein such conical sections are fabricated utilizing the parting method disclosed in earlier disclosures by same author. Embodiments of the present invention provide what are seen to be more economical, frustum-shaped, conical concentrator (80) that are fabricated by such methods.

In particular, present embodiments preferably utilize corrugated metal wherein the inventive conical concentrator is formed as a series of alternating layers comprising a wound corrugated sheet interleaved by a substantially smooth sheet. In certain embodiments utilizing a wound preform structure from which conical frustums are parted, the wound layers of sheet metal (163) in the present embodiments are interleaved with a relatively simple corrugated structure, which is presented in its most generic form, in FIG. 1(a), such prior art corrugated structure comprising preferably a corrugated aluminum metal sheet, similar to corrugated sheet used in the construction of aluminum honeycomb structures of the previous embodiments. A corrugated aluminum sheet (352) is accordingly formed having as a series of substantially parallel ridges, or undulations, in the sheet, such that the resulting corrugated sheet possesses first, or top, attachment ridges (354) on one side of the corrugated sheet (352), and opposing, or bottom, attachment ridges (353) on the second opposing side of the corrugated sheet. The opposing ridges of the corrugated sheet are separated by the sidewalls (355) of the corrugated sheet, wherein, in preferred embodiments, immediately adjacent sidewalls of the corrugated sheet will preferably have a non-parallel relationship with each other and more preferably form an angle φ′, such that preferably this angle is between 10 degrees and 170 degrees, and more preferably 30 degrees≤φ′≤80 degrees.

These surface ridges (353) (354) of the corrugated sheet comprise opposing attachment surfaces and are preferably attached to adjacent layers of the interleaved wound metal sheet (163) that are interleaved with the corrugated sheet. Cylindrical preforms are thus constructed similar to previous embodiments of wound cylindrical preforms, wherein the corrugated sheet (352) of the present embodiment is interleaved between wound metal sheets (163) of the cylindrical and tubular preform structures in the aforementioned applications by same author.

It will be understood that a regular corrugated material is characterized by a regular waveform accordingly comprising a characteristic waveform shape having a waveform period, such as represented by wavelength, λ, in FIG. 1(a), indicated between ridge-surface mid-plane axes; and, in the case of typical hexagonal core-materials, this repeating waveform shape of the constituent corrugation layers is essentially a truncated saw-tooth waveform, as represented by the various corrugated profiles disclosed herein. Various other characteristic waveforms may, of course, be utilized in the invention, as contemplated in previous applications by same author; however, in accordance with the preferred embodiments, the truncated saw-tooth waveform is chosen for purposes of teaching the invention in its preferred embodiments.

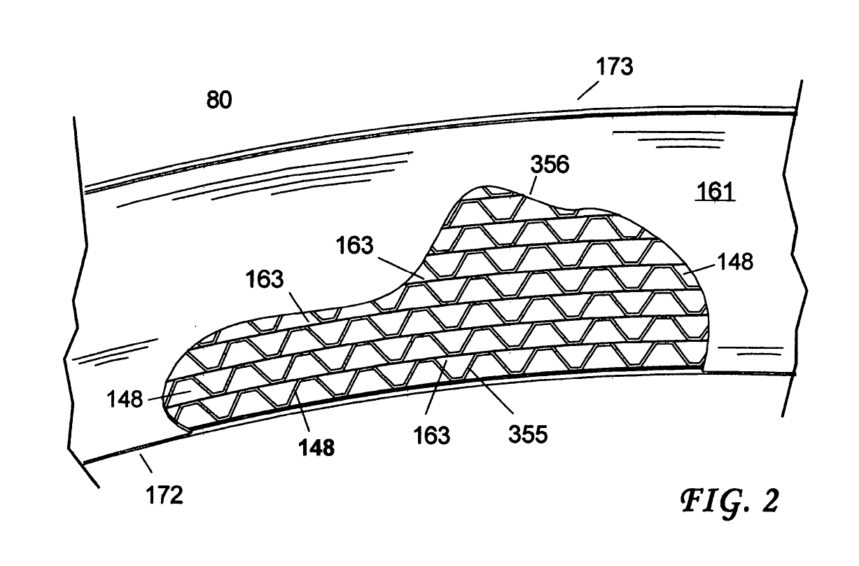

The conical structure (80) in the present embodiments are accordingly formed with similar, though more particular, geometric relationships provided in previous disclosures by same applicant. Accordingly, in FIG. 1(b) and FIG. 2, a resulting conical concentrator comprises cladding reflective sheet material (161) forming the interior conical surface and the second flexible sheet material (162) attached to the outer parted surface, forms the outer conical surface. The various mating surfaces of the frustum-shaped conical concentrator will be preferably fastened to each other by means of organic adhesives, preferably a silicone, or alternatively, a phenolic, acetates, epoxy, or other suitable organic adhesive. Alternatively, other fastening methods, such a spot-welding, riveting, etc, may be utilized.

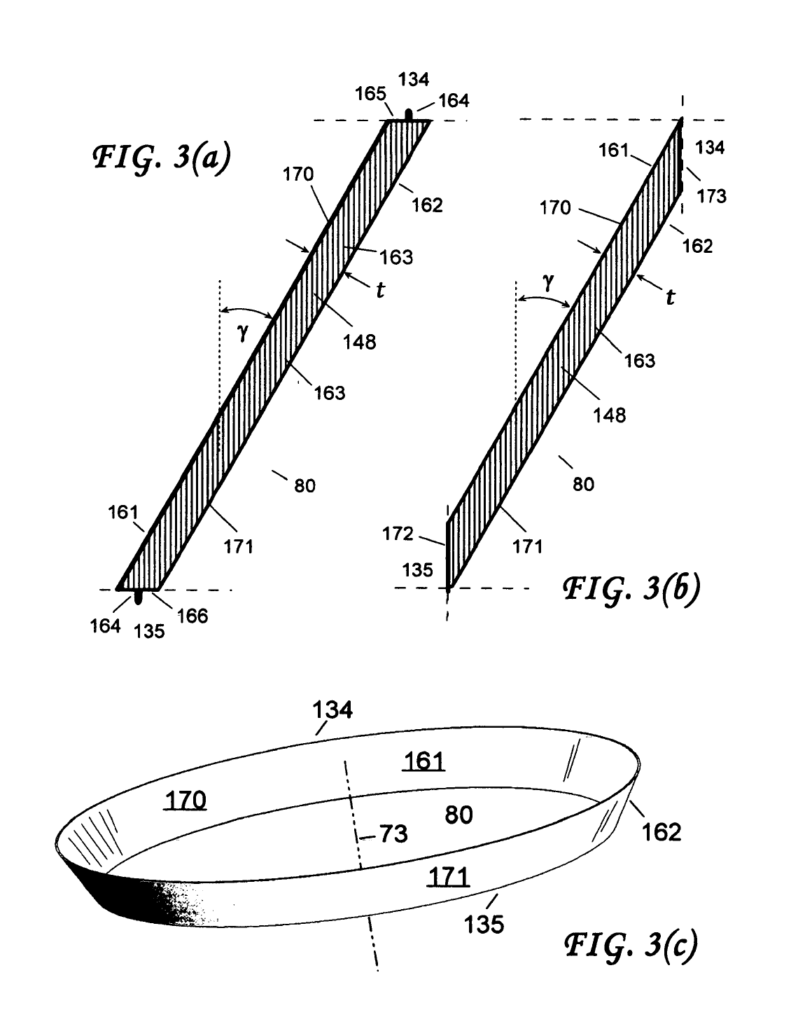

As in previous embodiments of the related applications, the conical concentrator (80) of the present embodiments is constructed with the preferred inner and outer cylindrical edge-walls (172) (173). The edge-wall surfaces that join to adjacent conical frustums of the CCC preferably have cylindrical surfaces, in FIG. 1(b) and FIG. 3(b), but can also have planar surfaces, be continuous, discontinuous or digitized, or any combination of such features, but preferably are constructed so as to align and mate to mating edge wall surfaces of an adjacent, concentric, conical frustum structure, in accordance with previously embodied CCC embodiments, preferably by means of an intermediate polymeric structure providing an interconnection structure between the two mating frustum structures, wherein interlocking mechanisms such as a plurality of tapered insert features, or keyed twist-lock features, have been contemplated as separate or combined within the polymeric structure.

Section line A is the intersection line created by the front-surface reflective sheet material (161) and sectional plane containing central axis (73) of the embodied conical concentrator (80); and section line B is intersection of the rear-surface sheet material (162) and this same sectional plane containing central axis (73) of the embodied conical concentrator (80). Accordingly, the section plane containing A and B, in FIG. 1(b) will intersect a plurality of substantially concentric layers of the wound metal sheet (163), intersected by wound layers of the corrugated material (352).

Various fold lines of the periodic corrugation are indicated, wherein a repeating period of the corrugation will exist between corresponding fold lines, such as the repeating corrugation period defined between fold lines (554) and (555), in FIG. 1(a).

The interior structure of the inventive conical concentrator is characterized by a large multitude, preferably greater than one hundred per conical concentrator, of separate cells formed by intercepting interior walls of the corrugated structure. Preferably, the cells are formed by at least one pair of substantially parallel walls, and so that preferably a cell located near the top of the conical frustum has structural walls substantially parallel to structural walls of a cell located near the bottom of the same frustum structure (80).

It is also preferred that these parallel walls, such as formed by wound sheet metal separators (163) or by the embodied parallel fold lines in the associated corrugated metal (352), form cell walls of the internal core structure that are substantially parallel to the central optical axis of the frustum structure. In other words, it is preferred that the cells are defined by structural walls that are, in one aspect, roughly parallel to each other and parallel to the optical axis (73).

As in previous embodiments of the related prior applications, the present embodiments are preferably utilized in a conical reflector (80) that is self-standing and rigid by virtue of the structures and fabrication methods utilized, in FIG. 3(c).

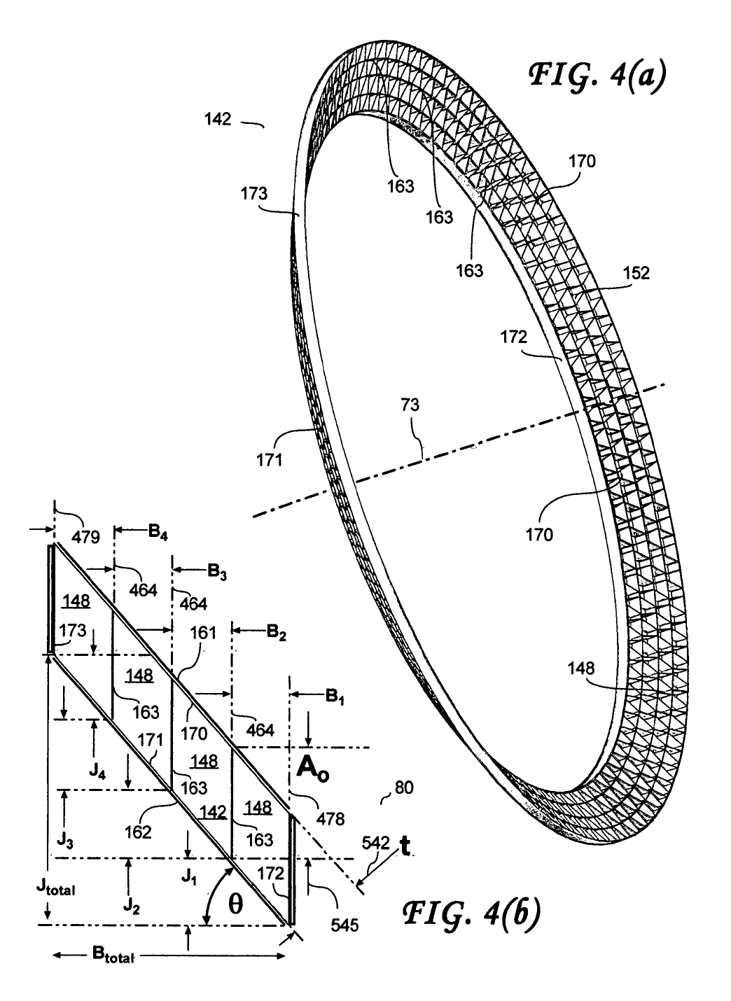

A right-conical frustum-shaped core structure, incorporating a modified honeycomb core structure of the first preferred embodiments, in FIG. 4(a), possesses radial symmetry by virtue of step-wise modification of each concentric layer of corrugated material. The disclosed radial symmetry of the frustum-shaped, right-conical, core structure (142) enables both the embodied high-throughput manufacturing path as well as a highly deterministic modulus in the resulting large optic of the preferred embodiments. The large optic comprises a solar concentrator, preferably incorporated into a multi-frustum concentrator utilizing a multitude of differently-angled frustums. As in previous embodiments of related applications, the frustum-shaped core structure is formed through separation from a preform structure, and, accordingly, the frustum-shaped core structure has an inner parted surface (170) of the parted frustum core and outer parted surface (171) of parted frustum core, where the frustums are consecutively separated in the embodied parting operation, such that inner and outer parted surfaces accordingly conform to a conical surface-of-revolution.

The embodied surfaces of revolution (170) (171) accordingly comprise the multitude of cut and exposed edges, of the embodied corrugated media, that result from the embodied parting process.

As in previous applications of which the present application is a continuation, the frustum-shaped core structure of the first preferred embodiment is formed from corrugated flexible sheet, most preferably thin metal sheet or foil, which comprises multiple sheet segments having, in their sectional aspects, an axis parallel to the central axis (73). It is more particularly preferred that the resultant core structure (142) comprises annular regions of corrugated sheet (148), or “corrugation layers”, that are separated by cylindrical, interfacial sheet segments (163) that are also parallel to the central axis, in FIG. 4(b), where the sectional angle, θ, is that of the conical aspect of external surface (171) of the exposed frustum core, and its subsequent cladding layer (162), with respect to its cone base, which is, in the preferred embodiment, the compliment of angle γ of front reflector (161), in sectional profile, to the vertical central axis (73). Accordingly, in the preferred embodiments, reflective cladding layer, and external cladding layer, are concentric and parallel surfaces, in their sectional profile. The thickness (542) of frustum core cross section, t, is the spacing between outer surfaces of the frustum structure.

In order to best set forth the invention in its preferred embodiments, basic mathematical/geometric metrics are introduced, in FIGS. 4-7, all of which will be well-understood by one skilled in the art; namely, such metrics comprise basic mathematical tools, such as radial axes, linear dimensions, angles, arc-lengths, chords, and segments as they are applied to fundamental geometrical analysis of circles and right cones.

More particularly, in the preferred structural embodiments of the present invention, specific spatial relationships are delineated with respect to the embodied frustum structure (80), wherein the latter has conical cladding layers (161) (162) attached and conforming to the parted conical surfaces of the frustum core structure (142), thereby forming a conical sandwich-type structure with its hollow-core media comprising the frustum core structure (142). The specific relationships of the present invention require identification of the individual radial spacing, Bₙ, between adjacent corrugation layers (148), as measured in radial direction between the mutually concentric, interfacial sheet segments (163). In conjunction with the specific embodiments set forth, these radial spatial dimensions comprise B₁, B₂, B₃, and B₄, in FIG. 4(b).

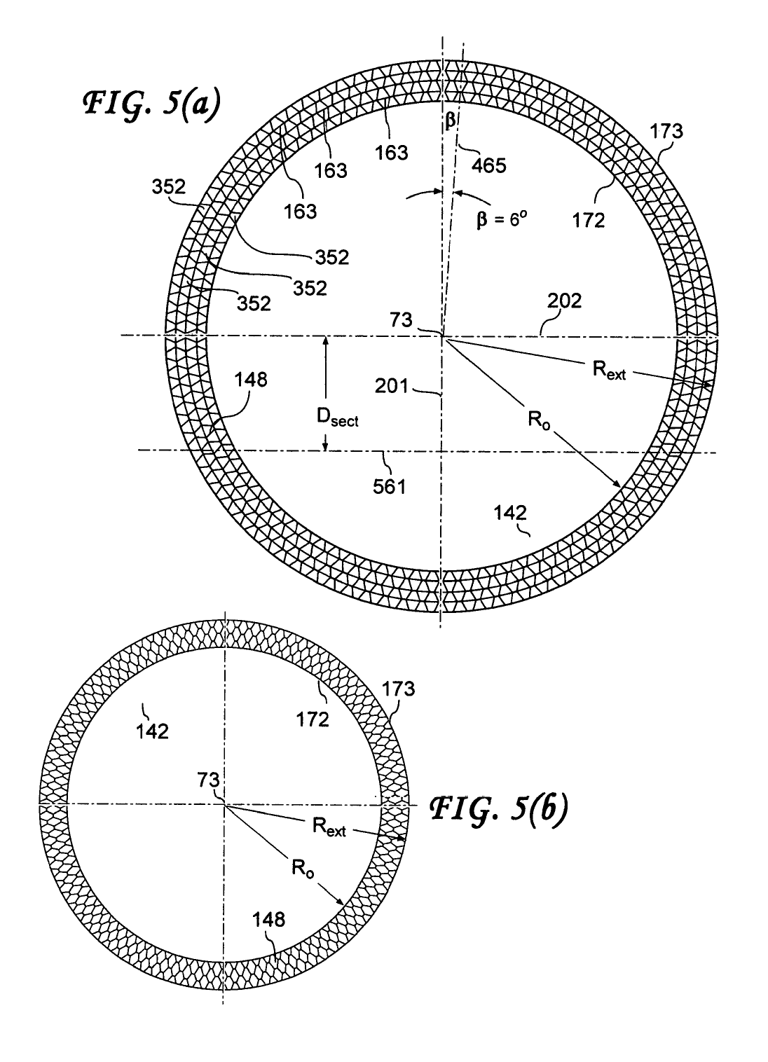

In the first preferred embodiment, where interfacial layers (163) are utilized, the abstracted interfacial surfaces (464), dividing adjacent layers of corrugated material (148), in FIG. 4(b), will be defined as residing at the center of the interfacial layer thickness. Since the interfacial layer thickness is, in the preferred embodiments, on the order of one to several thousandths of an inch (0.001″), whereas the embodied frustum structures are, preferably, on the order of a meter or more in diameter, either structure, in FIG. 5(a) or FIG. 5(b), can be understood and made via the same embodied processes and tooling, without significantly altering the remaining dimensional characteristics of the embodied structure. Such flexibility in the same general design and manufacturing approach may additionally be appreciated, since a typical adhesion layer, bonding joined ridge surfaces (350) of adjacent corrugation layers of the prior art, can readily be adjusted to a thickness, via conventional means of adjusting viscosity, to thickness' of same order as that of the preferred interfacial layer (163).

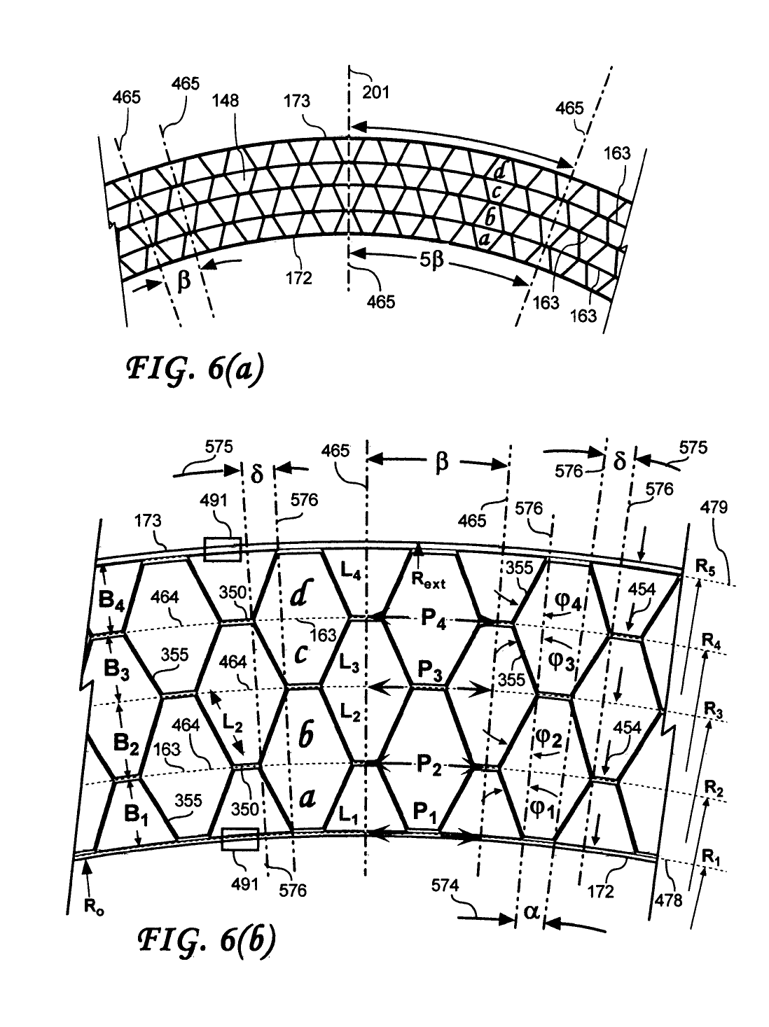

Accordingly, it will be understood that the alternate designation of an abstracted cylindrical interfacial surface (464), or depiction of the preferred cylindrical interfacial layer (163), in the various preferred embodiments, will, in either case, uniformly specify a cylindrical surface delineating the interface between adjacent, concentric, corrugation layers (148) of the corrugated material, in FIGS. 4-6, where the interfacial surface (464), in FIG. 6(b), indicates the preferred location of the interfacial layer, where it is eliminated for clarity.

The radial spacing is measured between these adjacent interfacial surfaces (464), each concentric and cylindrical, and of which each are axially parallel and concentric to the central axis (73), in FIG. 4(b), wherein Bₜₒₜₐₗ is the total sum of such radial spacing widths residing between inner and outer surface-edge structures in the radial direction, where a stack of qₜ (where n=1, 2, 3, . . . qₜ) corrugation layers has (qₜ+1) interfaces. Accordingly, at the inner and outer perimeters of the embodied frustum core structure, inner-edge interfacial surface (478), delineating the interface between the first corrugation layer and the inner surface-edge structure (172), determines the first radius R₁; whereas, outer-edge interfacial surface (479), delineating the interface between the outermost corrugation layer and the outer surface-edge structure (173) determines the outermost radius Rₙ₊₁, of the outermost, or nth, corrugation layer, where Rₙ₊₁=R₅ in the exemplary 4-layer structure of the preferred embodiments, in FIG. 4(b).

The embodied spatial relationships also include the axial displacement, Jₙ, between adjacent ridge interfaces centered on the interfacial surfaces, which in the specific embodiments comprise J₁, J₂, J₃ and J₄ in FIG. 4(b), which are, in the preferred embodiment, equivalent to the axial displacement of the interfacial foil layers, as measured in the direction of central axis (73), in FIG. 4(b). Accordingly, Jₜₒₜₐₗ is the sum of such axial displacements residing between inner and outer surface-edge structures in the axial direction. In the first preferred embodiments, conditions are roughly as follows: J₁=J₂=J₃=J₄; and, B₁=B₂=B₃=B₄.

The axial displacement Jₙ follows from the required conical profile, via cutting along the described surfaces of revolution (170)(171) into the axially aligned corrugated foil. The axial displacement, Jₙ, will, equivalently, also identify the axial displacement (along the corrugation fold lines) between the upper ridge surface (354) and lower ridge surface (353) of each individual corrugation layer disposed between two adjacent interfacial surfaces, as may be visualized in the alternative embodiment where no interfacial layers (163) are present. The cross-sectional thickness, t, as in previous applications by same author, comprises the distance between opposed surfaces (170) (171) of the frustum core structure (142), in FIG. 4(b).

In addition to the axial displacement, Jₙ, the axial depth, Aₒ, of the frustum cross-section, measured along central axis (73) direction, in FIG. 4(b), will primarily comprise the width of both ridge-surface segments (355) and interfacial strips (163) forming the cylindrical interfacial foil separating concentric regions (148) of corrugated foil (the “corrugation layers”).

In accordance with the embodied conical frustum structure, in FIGS. 4-6, cellular structures are formed within each concentric layer of the structure, and more particularly, the cellular structure of one concentric corrugation layer (148) possesses specific pre-determined angular and structural relationships with other layers in the frustum structure.

In the first preferred embodiment, the right-conical, frustum-shaped core structure (142) comprises a concentrically layered structure comprising a multitude of roughly coplanar side-wall segments (355) that are, in one aspect, parallel to the central axis (73) of the structure, in FIG. 5(b). In the preferred embodiment, these roughly planar segments comprise a corrugated aluminum sheet, or foil, material. It is further preferred that the layers of roughly planar segments be separated by concentric, cylindrical layers of a sheet material, preferably of the same material composition as that of the planar segments. As in previous related applications the segmented planar sections are realized through implementation of methods in corrugated sheet/foil commonly utilized in the art of manufacturing honeycomb core materials.

In the first preferred embodiment, a structural core of the embodied conical core structure (142) is comprised of the concentric outer cylindrical and inner cylindrical edge-surface structures (173) (172) having central axis (73), so that the edge-structures define an annular, conical volume in which is disposed multiple layered, corrugated structures each comprised of a corrugated sheet material that is also, in a sectional aspect, parallel to the central axis (73).

Moreover, the corrugated sheet material in each concentric corrugation layer is formed with periodic waveform of a marginally different arc-length Pₙ relative to adjacent corrugation layers, such that the resulting corrugation periods of each layer together form an angularly repeating radial pattern, with an angular period β. In this way, the separate layers of the frustum structure together form a repeating radial pattern that possesses rotational symmetry about the central axis (73), in FIG. 5(a-b). For example, in the first preferred embodiment, in FIG. 5(a), the rotationally repeating structure comprises four layers of structured core material, preferably corrugation layers (148) each comprising a corrugated aluminum foil, wherein the layers are separated by three concentric and cylindrical interfacial layers (163) of aluminum foil, such that the four corrugation layers together form a repeating radial pattern that is repeated every 6 degrees, such that, accordingly, in the exemplary embodiment, the entire frustum-core structure (142) comprises the same pattern repeated a multiple of ninety times. Thus, the repeating radial pattern, having angular period, β, in FIG. 5(a), is repeated an integral number of times, e.g., 90, in order to provide the resultant 360-degree annular structure (6°×90 periods=360°). Accordingly, within in a plane orthogonal to the central axis (73) containing mutually perpendicular axes (201) (202), the repeated pattern is characterized by the characteristic angular period, β, in FIG. 5(a), where β is defined as the periodic solid angle demarcating a repeating spatial relationship between at least two, and preferably all, separate, roughly concentric, corrugation layers within the embodied frustum core structure. It is more preferable that this solid angular period, β, of the layered assembly is simultaneously characterized by containing a constant number of corrugations in each concentric layer of the core structure. More specifically, in the structure of the first preferred embodiment, in FIG. 5(a), this number of corrugations in each layer, definable by an angular period β, is both an integer, and the same integer, in each corrugation layer.

In an alternative preferred embodiment, in FIG. 5(b), an exemplary structure replicates that of the first preferred embodiment, in FIG. 5(a), except that the interfacial layers (163) are not included, so that a modified open honeycomb structure having the specific radial symmetry is formed.

A preferred means for achieving objectives of the present invention includes construction of separate corrugating means that produce a different spatial waveform for each separate corrugation layer, labeled a, b, c, and d, in FIG. 6(a-b), of the embodied frustum core structure. Accordingly, an individual corrugation layer's spatial period, accorded a periodic arc-length, Pₙ₊₁, is increased, relative to the periodic arc-length, Pₙ, of the underlying layer, so as to provide the same angular period of the underlying layer.

In the various embodiments, radial axes are defined that each comprise axes intersecting the central axis (73), and which reside in a plane orthogonal to the central axis. In the preferred embodiments, radial corrugation axes (576) are radial axes that intersect corrugation layers at the intersection of the ridge-surfaces (353)(354) with the side-wall segments (355) so as to intersect, and be orthogonal to, the respective fold lines adjoining these two regions of the corrugated foil, in FIG. 6(b).

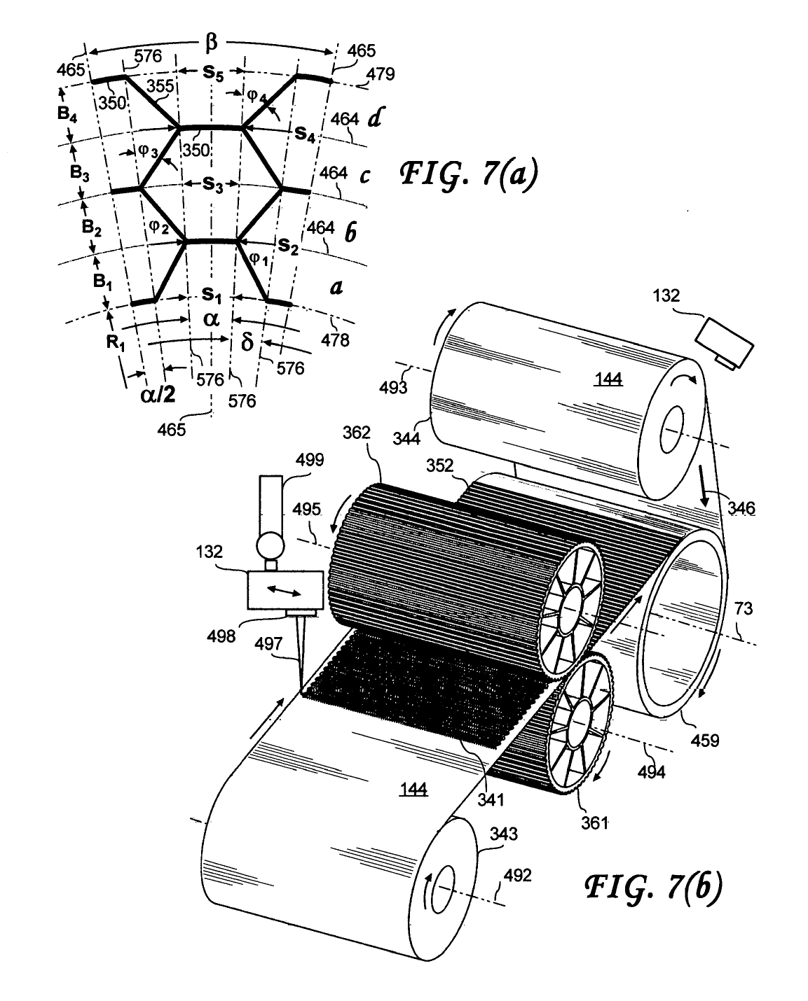

Also, it may be observed that, in FIG. 6(b) and FIG. 7(a), parallel fold lines (551) (552) (553) (554) (555) of adjacent corrugation layers align at regular intervals so as to be mutually intersected by one identical radial corrugation axis (576). Similarly, joined ridge surfaces (350) of the preferred embodiments will also preferably align to periodically spaced, ridge-surface centerline axes (465) that are mutually aligned to the joined ridge surfaces (350) in adjacent pairs of corrugation layers.

For purposes of teaching the invention, a “ridge-surface centerline” is defined herein as a radial axis within a plane orthogonal to the central axis (73) and intersecting the central axis, where the ridge-surface centerline (465), in the preferred embodiments, demarcates the center (mid-point) of the ridge-surfaces in at least two concentric corrugation layers that are accordingly aligned on the radial centerline axis (465), in FIGS. 5-6. These intersection points are preferably at adjoined interface ridges (350), as seen in the more magnified views of the preferred embodiment, in FIG. 6(b). Accordingly, in the first preferred embodiment, an angular period of the corrugation waveform, β, of the multi-layer frustum core, can be demarcated between two consecutive ridge-surface centerline axes that both intersect either consecutive top ridge surfaces (354), or else, consecutive bottom ridge surfaces (353).

Since the present invention utilizes corrugated media preferably having a corrugation profile of a periodic waveform, the normal convention of waveforms provides for designation of the opposing ridge-surfaces (353)(354) of a corrugation layer as accordingly anti-nodes of the associated waveform, which is preferably resembling that of roughly a truncated saw-tooth waveform, consistent with the corrugated foil used in honeycomb-type cellular media.

Accordingly, in the first preferred embodiment, the various ridge-surface centerline axes (465) of the assembly's periodic radial pattern defines a periodicity of solid angle, β, whereas centerline axes are preferably identifiable at angular intervals of quantity, β/2, since centerline axes demarcate both upper anti-node, or ridge-surface (354), and lower anti-node, or ridge surface (353) in the embodied corrugation waveform of the preferred embodiments.

Accordingly, whereas a repeating spatial period of the corrugation waveform may be demarcated variously at nodes, anti-nodes, or anywhere else along the periodic trace, the convention used herein will be to measure individual periods of the waveform from the center of their anti-nodes, which is accordingly, herein, the center of either bottom ridge-surface (353) or top ridge surface (354).

It is preferred that centerlines of concentric layers align at regular intervals to form a symmetric, periodic, radial pattern. Moreover, in the first preferred embodiments, each corrugation layer of a frustum core structure contains the same number of corrugation periods, so that, accordingly, each anti-node, or ridge-surface, of a corrugated structure, in one corrugation layer, is aligned and mated to the corresponding and opposing ridge-surface (or anti-node) of the underlying corrugated ring, in FIGS. 5-6, so that ridge-surface centerlines (465) of joined ridge surface unions (350) are roughly coincident throughout all corrugation layers within the annular thickness of the frustum core structure.

In the first preferred embodiment, at least one interleaving layer of foil separates the concentric ring-shaped layers of corrugated foil, a, b, c, d, in FIG. 6(b), thereby improving strength and rigidity of the resulting clad structure. Alternatively, the interfacial layer bay be composed of multiple layers, or, may be considered to be eliminated, in FIG. 5(b), such that interfacial cylindrical surfaces (464) that delineate the interface between adjacent corrugation layers, as embodied in conjunction with FIG. 4(b), may comprise only a direct interface between the respective ridge surfaces (353) (354) of this interface between adjacent corrugation layers, with only an organic adhesive layer as conventionally incorporated between corrugation layers of honeycomb construction, accordingly with no interleaving interfacial foil between aligned and joined ridge surfaces (350) of the resulting, modified honeycomb, pattern.

A corrugated layer (352) disposed within the core structure (142) is preferably defined by having a characteristic repeating corrugation waveform, an example of which is indicated by the corrugation pattern residing between ridge-surface centerline axes (465), in FIG. 5-6b, or alternatively, in FIG. 7(a). These ridge-surface centerline axes defining there-between the characteristic repeating features (periodic feature, or waveform period) that defines the corrugation waveform pattern. It is preferred that the same two radial axes define there between a single corrugation period at each of the corrugation levels (a, b, c, d) in FIG. 6(b) and FIG. 7(a). Stated equivalently, it is most preferred, in the present invention, that each layer of corrugation (a, b, c, d, . . . etc.) in the preform and resulting frustum structure, possess the same integral number of angular corrugation periods, β.

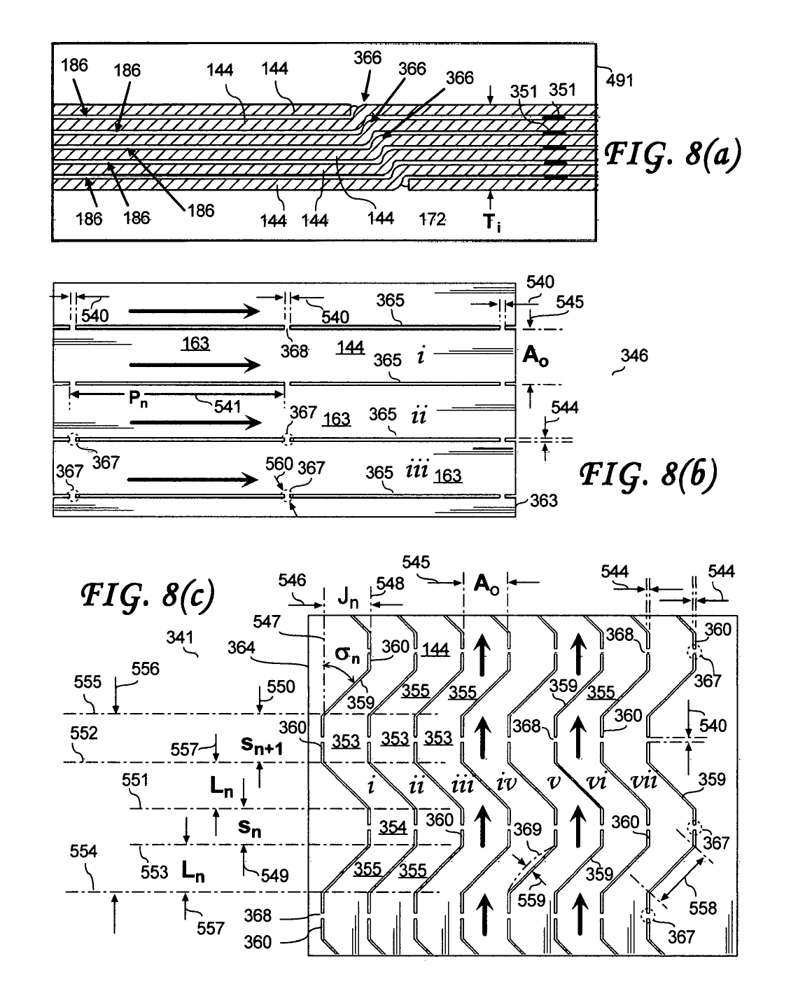

The various radius measurements of the invention, measuring the radius from central axis (73), defined, in FIGS. 5-6, as R₀, R₁, R₂, R₃, R₄, R₅, Rₑₓₜ, where corrugation radii, R₁, R₂, R₃, R₄, R₅, measure the radius of the successive, cylindrical interfacial surfaces (R₂, R₃R₄) and cylindrical edge interfacial surfaces (R₁, R₅) along which are joined the respective ridge-surfaces of the respective corrugation layer. The radii demarcating the inner and outer radius of the embodied frustum core structure, R₀ and Rₑₓₜ, in FIG. 5(a), are differentiated from respective adjacent radii, inner radius R₁, and outermost radius, R₅, of the exemplary corrugation layers, a, b, c, d, by the thickness' of their adjoining edge-surface structures (172) 173), which is preferably the embodied multilayer edge-surface structures described later, in FIG. 8(a).

Since the side-wall features of the corrugation layers will preferably retain a roughly planar profile in the core structure, The length Lₙ of side-wall sections in the corrugation layers (148) of the frustum core structures (142) will be the same as that determined in corrugation of the layer, which is the distance between respective fold axes (151) and (152) in FIG. 1(a), where L₁, L₂, L₃, L₄, in FIG. 6(b), is accordingly the length of the side-wall extending between the interfacial layers (163), or between interfacial surfaces (464), in alternative embodiments where when interfacial layers are not included. In the various variables presented herein, the subscript 1, 2, 3, 4, corresponds to dimensions associated with the corrugation layers, a, b, c, d, respectively, in accordance with the representative figures, FIGS. 1-11.

In the preferred embodiments, the constant angular period β also includes sub-component solid angles that are constants of the overall assembly of corrugation layers. These sub-component angles comprise a ridge-surface angle, α, defined as the angle between radial corrugation axes on either side of mutually aligned ridge-surface unions (350), and the corrugation solid angle δ, defined as the angle between radial corrugation axes intersecting fold lines on either side of mutually aligned (between corrugation layers) side-wall regions (355), in FIG. 6(b) and FIG. 7(a).

Side-wall angles, φₙ, are defined as the angle between angles of side-walls (355) and radial axes (576) that intersect either edge, or, equivalently, fold line, of that side-wall; thus, a sidewall of angle, φₙ, will extend between interfacial surfaces (464) of radius Rₙ and Rₙ₊₁, at which junctions reside the corrugation axes (576) that define the sidewall's angle, φₙ, which is identically measured from either axis, in accordance with basic geometrical analysis. Accordingly, as may be seen in conjunction with the preferred embodiments in FIGS. 6(a-b), β=2δ+2α, where angles herein shall be in radians, unless specified otherwise.

It is therefore a primary aspect of the invention in its first preferred embodiment, that the corrugation layers are individually formed and disposed with separate spatial dimensions so as to provide a mutual radial alignment of ridge surfaces at regular angular intervals in the embodied frustum core structure.

Arc-lengths defined for purposes of disclosing the invention are measured along the embodied interfacial surfaces (464) (478) (479) that roughly delineate the interface between concentric and adjacent corrugation layers. Accordingly, such arc-lengths are coincident with the preferred interfacial layer (163) and, with or without interfacial layers, roughly coincident with interface of the joined ridge-surface segments (355) disposed within the frustum core structure. At the outer layers of the embodied frustum core, such arc-lengths are also coincident with the curved ridge-surfaces that interface the surface-edge structures. The arc-lengths of particular interest are, particularly, the periodic arc-lengths, Pₙ, associated with the individual corrugation waveforms of each corrugation layer; and, also, the ridge-surface arc-lengths, sₙ, of the corresponding ridge surfaces, defined between corrugation axes (576) at either side of a ridge surface union (350) in the frustum core structure, in FIG. 6(b) and FIG. 7(a).

In the first preferred embodiment, wherein each corrugation layer of corrugated foil, a, b, c, d, in FIG. 6(a-b), contains an identical number of corrugation periods within the frustum core's angular period β, it may be further seen that each corrugation layer, with associated Bₙ, Jₙ, comprises an individual, spatial, corrugation period characterized by an inner arc-length Pₙ, in FIG. 6(b).

Accordingly, in the preferred, exemplary embodiment of FIGS. 4-11, the periodic arc-length, Pₙ=βRₙ (where subscript variable n=1, 2, 3, 4, in the exemplary embodiments), and therefore equals the arc-length as measured along an adjacent interfacial surface of radius Rₙ, defined between ridge-surface centerlines that also, in the preferred embodiments, demarcate a full angular period β, of the multi-layer frustum core's radial pattern. All angles herein shall be in radians except where particularly specified in degrees.

In accordance with the circular geometry and described radial symmetry of the embodied frustum core structure, the arc length, Pₙ₊₁, of an interfacial surface of the frustum core assembly is greater than the arc length, Pₙ, of a more interior interfacial surface, for a given angle, such that the inequality, P₁<P₂<P₃<P₄, holds.

Since the interfacial foil is, preferably, negligibly thin in its displacement effects, the ridge surface arc-length, sₙ, is defined along the interfacial surface (464) separating the adjoining two ridge surfaces in a ridge surface union (350). Accordingly, in the first preferred embodiment, the ridge-surface arc-length sₙ=αRₙ and therefore equals the arc-length of a corresponding ridge-surface, as measured along the corresponding interfacial surface, and demarcated by the corresponding fold lines of the respective ridge surface; and thus, equivalently, demarcated by adjacent corrugation radial axes (576). This arc-length, sₙ, is roughly equal to the arc-length of both adjoining ridge-surfaces at the respective ridge-surface union (350). Ridge-surface arc-lengths can be further and readily resolved to even more precisely exact dimensions by factoring in for a specific adhesive thickness joining the ridge-surface unions (350), as well as for the preferred interfacial aluminum layer; however, since the preferred interfacial layer thickness and adhesive is on the order of thousandths of an inch (0.001″), such adjustments (which will uniformly and symmetrically alter the structure axially by an insignificantly small increment) will not normally affect the resulting measured optical or structural performance in the typical solar application.

In the preferred embodiments, the example used has a specific number of corrugation layers, qₜ, wherein qₜ=4, (n=1, 2, 3, 4) for purposes of disclosing the embodied structure. It will be understood that this number of layers can vary greatly, depending upon the specific application. In the preferred embodiments, the number, qₜ, of corrugation layers in a frustum core structure, qₜ, is preferably in the range, 1>qₜ>100, and more preferably in range, 2>qₜ>20.

The radial width per corrugation layer is preferably in the range, such that 0.2 cm>Bₙ>10 cm, and, more preferably, 0.5 cm>Bₙ>5 cm, where accordingly, given the preferred range of frustum angles, θ, defined by the various angles of a multi-frustum optical concentrator, preferably where, 0.17 rad<θ<1.4 rad, the preferred range of Jₙ is thus defined preferably in roughly the same ranges as Bₙ.

The identifiable angular period β is preferably in the range, such that 0.001 rad>β>0.53 rad, and, more preferably, 0.003 rad>β>0.21 rad. It will be understood to those skilled in the art that, for various dimensions of the present invention, any physically possible values may be alternatively utilized.

The most cost-effective and expedient means of assessing the precise dimensions, in the preferred embodiments, and therefore, the preferred method for generating the relevant dimensions, is through the numerical methods of 3D CAD programs. Accordingly, this is by first generating the embodied frustum structure in a commercially available, 3-dimensional solid modeling software—such as Solid Works, Pro-E, CATIA, etc.—in accordance with the disclosed structure herein, wherein the embodied structural restraints are placed on the various radii and overall dimensions of the desired frustum-shaped concentration structure (80). In such preferred methods, one skilled in the art of 3D modeling may readily generate the embodied structure and transfer the numerically-generated dimensions to a spreadsheet, or, more preferably, transfer the relevant dimensions directly to a conventional tool-path software utilized by the preferred, numerically-controlled cutting apparatus, as is commonly and widely performed routinely in modern fabrication facilities.

In a less-preferred, alternative method, one may generate the needed dimensions through analytical expressions evaluated for each specific segment of the frustum core structures and cladding layers, where the relevant expressions directly derive from standard analytical geometry. In this alternative embodiment, conventional axes, planes, angles, arc-lengths, radii, and chords, and segments of analytical geometry, as they relate to circles and cones, are sufficient to specify all geometrical requirements of the invention. Accordingly, such geometry is readily treated by the methods of analyzing circles and cones as commonly introduced in textbooks in analytical geometry.

Namely, the basic desired dimensions of the conical structure (80) are the pre-selected radii Rₙ, which are determined by the desired layer width Bₙ, where Bₙ=(Bₜₒₜₐₗ/qₜ), where qₜ is the desired number of corrugation layers in the desired frustum core structure (n=1, 2, 3, . . . qₜ). Similarly, axial depth Aₒ, θ, determining Jₜₒₜₐₗ, and all Jₙ, are determined directly from the desired frustum geometry. Also, a desired density and concomitant size of cells is selected, with associated angular period, β. In order to fabricate the required corrugated material for each layer of the preform and constituent frustum cores, one first decides the desired density of corrugation layers, and optimal corrugation angle δ, as defined by adjacent radial corrugation axes (576), which will typically be smaller than the ridge-surface angle α, where these sub-component angles are chosen so as to provide the side-wall angles in the preferred range, such that preferably, 0.5<δ/α<2, in FIGS. 6-7.

Analytical expressions may then be obtained from basic geometric relationships in the conventional manner, by way of defined axes, planes, angles, arc-lengths, radii, chords, and segments of analytical geometry, specifically as they are taught in relation to circles and cones. Resulting expressions giving the dimensions needed to construct the corrugation layers are thus obtained:

Lₙ=[(Rₙ sin δ)²+(Rₙ₊₁−Rₙ cos δ)²]^{1/2}

φₙ=tan⁻¹[(Rₙ sin δ)/(Rₙ₊₁−Rₙ cos δ)]

sₙ=αRₙ

Thus, in the present alternative method, dimensional requirements of corrugation layers forming the preform may be determined analytically, directly from the desired dimensions of the desired frustum concentrator (80). It will be clear to those skilled in the art that various analytical expressions may be derived from the embodied geometric relationships. For example, the side-wall angle φₙ may be further adjusted by allowing the ratio, δ/α, of corrugation angle δ to ridge-surface angle α to be varied between layers, while still maintaining an overall angular period β of the frustum core's radial symmetry.

As embodied in the earlier, related applications of the present invention, particularly in PCT/US2011/00966, a multitude of the embodied annular, frustum-shaped core structures (142) of the present embodiment is preferably formed by separating each of the individual core structures from the embodied annular preform, which is, in the preferred embodiment, made by winding successive layers of material about a core so as to form the desired annular preform structure (158). In the present invention, a specific embodiment and process for improved versions of such preform structures, enables high precision at faster throughput.

In the first preferred embodiment of the present invention, the embodied preform is fabricated and subsequently parted to form a multitude of conical frustum structures of a singular geometry, so that a manufacturing line for the preferred application, multi-frustum solar concentrators would preferably require constructing separate preforms for each individual frustum geometry of an ultimately produced multi-frustum concentrator, whether such multi-frustum concentrator is a step-wise continuous paraboloid of the preferred embodiments, or some other, alternate, multi-frustum design. Accordingly, an exemplary process and apparatus is disclosed, wherein any of the hollow-core frustum structures of a multi-frustum concentrator can be made in succession, or made simultaneously, by means of utilizing the present invention in accordance with the desired dimensions in each instance.

Broadly speaking, the presently disclosed preform process utilizes wound media that is pre-patterned, preferably through laser-cutting methods, prior to being incorporated into the preform structure, in FIG. 7. Feedstock for the individual corrugated media (352) of the preferred preform embodiments preferably comprises a roll of commercially available un-corrugated stock foil (343), referred to herein, by its end-form, as the “corrugation foil”, specifically disposed for the embodied corrugation structures; whereas, feedstock for the interfacial layers (163) is preferably a second roll of interfacial foil stock (344) specifically disposed for interfacial layers. Whereas foil stock is preferably commercial standard, rolled, Al-based foil stock, it may be laminated/coated with various other organic/inorganic materials known for increasing strength, reliability, or corrosion-resistance. The foil stock may alternatively also be patterned with a variety of small openings for the purpose of further optimizing strength-to-weight ratio.

Similar to the earlier-filed patent applications related to the present application, in the first preferred embodiment, multiple layers of corrugated foil are successively wound about inner cylindrical preform surface (572) of the embodied cylindrical preform. The preform is wound so as to incorporate the embodied corrugation layers of the resultant frustum core structures (142), and, accordingly, the various planar top-views of the preferred frustum core structure, in FIGS. 5(a) and 6(a-b), is thus identical to that of the corresponding preform of the preferred embodiments, as viewed along the central axis (73).

Accordingly, in the preform, the preform inner-surface (572) and preform outer-surface (573) are an extended cylindrical surfaces that ultimately become the constituent multitude of edge-surface structures (172)(173) of a corresponding multitude of parted frustum core structures (142), once the parting operation is completed.

Thus the parting operation cleaves many individual frustum core structures from the disclosed preform so as to provide the disclosed frustum-shaped core structure (142) that is consequently clad with external layer (162) and internal reflector layer (161) to result in the embodied frustum-shaped solar concentrator (80), which, in turn, is preferably incorporated into the preferred multi-frustum concentrator, variously referred to as a step-wise continuous paraboloid, or compound conical concentrator (CCC) of the preferred embodiments.

Accordingly, each successively wound layer of corrugated foil comprises an annular, cylindrical volume of successively greater outer diameter with the embodied dimensional requirements that are distinct for each corrugation layer.

A preform under construction (459) is formed by winding the discrete corrugation layers sequentially about the cylindrical inner-surface layer (572) of the preform, wherein the preform under construction is rotated about the central axis (73) of the resultant preform, which central axis is identical to that of the ultimately parted frustum core structures (142).

Accordingly, central rotation axis (492) of the roll of corrugation foil stock (343) is oriented parallel to other rotation axes of the present manufacturing apparatus so as to feed the corrugation stock through the corrugation means and then onto the preform under construction, in FIG. 7. Likewise, central rotation axis (493) of the second roll of interfacial foil stock (344), is oriented parallel to the other rotation axes of the manufacturing assembly, so as to feed the interfacial aluminum foil onto the preform under construction, thereby interleaving the interfacial foil with the corrugated foil in the manner disclosed in conjunction with the preferred frustum core structure.

During the winding process, mechanical support and rotation of the preform is preferably performed by conventional multi jaw chucking mechanisms commonly utilized for turning hollow cylinders, wherein the chucking means is preferably disposed for providing maximum contact to the preform interior surface, so as to be ideally disposed for also winding specific, multilayer, inner edge surface layers (572) of the preferred embodiments, which will be discussed in greater detail, in conjunction with FIG. 8(a).

Corrugation of the corrugation foil is preferably provided by corrugation means similar to those utilized generally in the corrugation of foil, wherein a common corrugation means comprises feeding the foil stock between two opposing and complementary mating surfaces having the desired corrugation features.

In the prior art of hollow-core structures utilizing hexagonal cellular media, or in similar media formed of a corrugated core material, such as cardboard packing, a standard means of forming corrugated media is commonly by means of rolling the flexible sheet material through opposing, mated corrugation rollers each having a complementary gear-shaped cross-section, whereby the corrugated shape of the wheel's gear-like cross-section is fashioned in accordance with the precise corrugated cross-section, or “flute” profile, desired, which may be triangular, sinusoidal, ribbed, etc. By selecting shape and pitch of the mating corrugated surfaces of the mated corrugation wheels, one may thus form the rolled sheet material into the desired corrugated form, as is commonly practiced. Thus, the corrugation wheel's flute dimensions and angles will be determined by the required corrugation dimensions, as is commonly performed in corrugated sheet materials.

In one aspect of the invention, similar known corrugation means are preferably utilized in the present invention, except that a separate pair of corrugation rollers with separately shaped flute profiles are utilized to fabricate each corrugation layer of one frustum-shaped core structure, wherein each concentric layer of corrugated foil in the disclosed frustum-shaped core structure, (142), is comprised of a distinct spatial corrugation period (or its spatial arc-length). Accordingly, a separately configured set of corrugation wheels for forming each corrugation layer having different spatial period, in FIG. 7(b), is preferably utilized for the separate layers of the embodied preform.

Corrugated structure is formed into the corrugation stock by namely, a first corrugation wheel (361) and second opposing corrugation wheel (362) forming corrugation pattern in the foil, wherein the first and second gear-wheels accordingly provide a complementary opposing gear-like profile, with accordingly fluted surfaces, appropriate for forming the desired corrugation profile in the corrugation foil stock. Accordingly, for each corrugation layer, the corrugation pattern is formed by opposing, large-diameter corrugation rollers (361) (362) having gear-like flutes of the desire corrugation form, in FIG. 7, with length of the rollers, as measured along their central axes, corresponding roughly to the width of the sheet being rolled through the corrugating rollers.

Thus, as is normally implemented in the corrugation of flexible flat stock, the central rotation axis (494) of first corrugation gear is oriented parallel to central rotation axis (495) of second opposing corrugation gear, wherein the corrugation foil from corrugation stock roll (492) is fed through the corrugating assembly prior to being wound onto the preform under construction (459). A wide variety of such corrugation means are available through commercial conversion-equipment contractors commonly utilized in corrugation of foils and paper, particularly for honeycomb core material.

Also, in other alternative means for corrugating the foil, conventional means also include the common method of passing individual sheets under a plurality of rollers that each indent the sheet with a single corrugation trough. As will be appreciated, whereas use of opposed corrugation rollers, in FIG. 7, appropriately shaped for providing the desired profile is common, it is not intended that the corrugations of the present invention be limited to such conventional means, as various corrugation profiles and corrugation means of the prior art may be applied in realizing alternated waveform structures without departing from the invention. For example, roughly sinusoidal waveforms may be alternately utilized to realize an identical symmetry. Spiral windings may alternatively also be utilized in certain less-preferred embodiments.

In an alternative embodiment, there may be an integral, but different, number of periods in each layer that results in similar radial symmetry, such that a similar spatial harmonic relationship exists between the respective layers (a, b, c, d). In such alternative spatial harmonic embodiments, ridge-surfaces centerlines of the corrugation layer are, as before, lined up between adjacent corrugation layers at regular angular intervals, except that these regular intervals may be greater than the individual angular period of at least one of the corrugation layers.

The individual angular period of respective corrugation layers, as associated with Pₙ can therefore be different from β and matched in spatially matched harmonics so as to align adjacent ridge surfaces at some regular interval of corrugation periods that is not corresponding to the same integral number of corrugation periods in every corrugation layer, and therefore not strictly one-to-one. In such an alternative embodiment, for example, the frustum core structure may contain ninety identical repetitions of the corrugation waveform in one corrugation layer, wherein the overall frustum core structure has an associated angular period of β=6 degrees; however, the next adjacent corrugation layer may have a layer corrugation-wavelength corresponding to twice this spatial frequency, so as to possess one-hundred-eighty full corrugation waves. In such latter circumstances, the second 180-period corrugation layer would accordingly align with the 90-period corrugation layer at an interval of once every two corrugation periods, thus retaining an overall repeating pattern of the specified angular period, β.

Accordingly, such spatial harmonics may thus also result in the frustum core (142) possessing a repeating radial pattern, with solid angular period β, that is larger than any of the angular periods having associated arc-lengths Pₙ, of individual corrugation layers; though, this more coarsely spaced radial symmetry, showing essentially a relatively long beat frequency between the assembled corrugation layers (a, b, c, d, . . . ) is a less preferred embodiment. In such alternative embodiments, it will be readily understood that the above types of spatial harmonics may be realized in any of a variety of schemes, with the same result of a repeating number of waveforms in each layer within the specified angular period, β, of radial symmetry characterizing the overall frustum core structure (142), thereby allowing the preferred ridge surface features (or, in alternative embodiments, other equivalently positioned anti-node features) of adjacent corrugation layers to be, as in the preferred embodiment, aligned at regular intervals.

In the preferred case that the resulting core media is used in solar concentrating frustums (80) having cylindrical edge-surface structures (172) (173), such surface-edge structures are also, preferably, providing an inner and outer cylindrical edge structure in the completed frustums (80). Alternatively, the preferred cylindrical edge-surface structures (172)(173) may be appended or altered by any additional trim structure having a different profile (e.g., sectional edge profiles that are planar, conical, curved, etc) may be incorporated into the upper and/or lower edges of the, completed and clad, conical frustum structures. Also, wherein such surface-edge structures may be interconnected to the surface-edge structure of an adjacent conical frustum structure, it is preferably by means of a separate, preferably at least partially polymeric, interconnection structure that is interconnecting the mating surfaces. It is preferred that the polymeric interconnection structures are disposed at interfaces between each pair of adjoining frustums (80) in multi-frustum concentrators of the preferred embodiments, wherein these polymeric interfaces preferably incorporate a plurality of interlocking features, such as taper features or alternatively keyed twist-lock features.

The caption box (491), in FIG. 6(b), is subsequently magnified, in FIG. 8 (a), so as to detail the preferred edge-surface structure (172) (173), of the frustum core structure (142), which comprises a preferred multilayer cross-section that is accordingly the same cross-section formed in both the respective inner and outer edge-surface structures of the embodied preform (158). Such compound edge-surface structures may also incorporate, in addition, various inter-locking features of previous embodiments.

As in previous applications by same author, these inner and outer surface-edge structures, in the first preferred embodiment, comprise flexible, rolled metal sheet, preferably comprising an aluminum alloy for engaging an adjoining frustum in a multi-frustum concentrator. In the present invention, it is additionally preferred that these surface-edge-structures comprise multiple inter-leaved layers of relatively thin aluminum foil (144), preferably of roughly the same thickness as utilized in the corrugated aluminum of the core structure, so that the resulting edge-layer comprises multiple alternating layers of the aluminum foil interleaved with layers of an adhesive organic resin (186), preferably a phenolic, or alternatively acetates, siloxanes, epoxies, or polyethylene-based resin, in FIG. 8 (a).

Such multilayer surface-edge-structures are preferably wound in the preform winding operation, wherein it is additionally preferred that successive layers of the surface-edge-structures incorporate a localized region of bend/kink features (366) that are formed in a region containing both terminated ends comprising the starting and ending edges of the constituent wound foil of the embodied edge-structure, in FIG. 8 (a), thereby resulting in the surface-edge-structure having a uniform cross-section thickness that uniformly incorporates an identical number of layers around the entire resulting ring. In an alternative embodiment, additional spacer/reinforcement structures (351) are disposed between these multiple foil layers of the disclosed multilayer surface-edge structure so as to additionally define a precise spacing between each constituent foil layer (144), as well as provide additional strength, wherein such spacer/reinforcement structures will preferably comprise filamentary windings, but may alternatively comprise any appropriate structural means, including additional, precision kink/seam, deformations formed at regular intervals in the constituent aluminum layers.

It will be readily understood that the embodied multilayer edge-surface structure may comprise a wide range of layer numbers and layer thicknesses, depending upon the specific rigidity/weight relationship sought as well as the precise thickness of metal sheet (144) being conveniently utilized.

A primary advantage of the present invention is an enhanced throughput that is enabled through use of pre-patterned foil stock that, once incorporated into the embodied preform (158), produces a preform structure that is patterned with an array of pre-cut, periodic cut/slit patterns that are coincident with the desired conical surfaces (170) (171) of the frustum core structures (142). Accordingly, when the frustum core structures are subsequently parted sequentially from the preform structure in the embodied parting operation, the effective linear cut profiles (157) that, when such linear profile is rotated about the central axis (73), define the desired conical surface of revolution, need not be realized by cutting means that conform structurally to this surface-defining linear cut profile; in fact, the cutting means, specifically a focused laser, is preferably only required to cut the structure in discretely located cut locations along the cut path, in order to part the desired frustum structure from the preform.

The aluminum stock foil from both stock-foil rolls is preferably pre-patterned by a laser (132) with a multitude of laser-cut slits, formed into the foil as a regular array. In the case of the interfacial-layer stock, a linear-cut pattern (346) is laser-cut into the interfacial-stock aluminum foil with a linear pattern formed along the length of the stock in its feed direction, where, in FIG. 8(b), this feed direction is indicated by four identical, horizontal arrows. In the case of the corrugation stock (343), an “angular-cut” pre-pattern (341) is laser-cut into aluminum foil, in FIG. 8(c), where in eight identical, vertical arrows in the figure indicate the feed direction. In the preferred embodiment of the preform construction process, in FIG. 7, the winding process is preferably incorporating multiple lasers that are forming the embodied pre-patterns (341)(346).

The pre-patterns thus form a series of consecutive (i, ii, iii, iv, . . . ) interfacial layers, in FIG. 8(b), and, consecutive (i, ii, iii, iv, . . . ) corrugation layers, in FIG. 8(c), in their planar, pre-wound, form. The preform is, once completed, subsequently separated into a series (i, ii, iii, iv, . . . ) of consecutive frustum core structures, wherein the identified series, i, ii, iii, iv, . . . etc., does not specify any particular frustum core structure in the preform, but only indicates any series of, identical and adjacent, constituent frustum core structures of the embodied preform; or else, as in FIG. 8(b-c), indicates identical components that are incorporated into such a series of identical frustum cores, wherein it will be understood that adjacent components so labeled are individually distinguished only by their incorporation into a corresponding series of consecutive frustum cores to be separated sequentially from the preform.

It may thus be seen that, in the flattened state, the desired outline of the pre-patterned components (i, ii, iii, iv . . . ) in these pre-patterns, in a series of either the interfacial layers or corrugation layers, is that outline which remains after removal of the defined tab features (368) of the pre-patterns, in FIGS. 8(b-c), in either of the embodied pre-patterns (341)(346).

It will further be understood that the flattened-state shape of each in a series of interfacial layers (i, ii, iii, iv . . . ) and corrugation layers (i, ii, iii, iv . . . ), will subsequently be formed, through the embodied corrugation/winding process, in FIG. 7, into the embodied preform structure, so that the cut pre-patterns correspond to the parting surfaces (170)(171) of a series of separate frustum cores (i, ii, iii, iv . . . ).

Accordingly, the sheet/foil stocks utilized in the winding process, in FIG. 7, are preferably treated with the embodied pre-patterned slit/cut arrays, preferably by laser means, or alternatively by mechanical stamping/slitting means, prior to application on to the preform structure under construction (459). Thus, the aluminum stock is preferably patterned in a flattened state with pre-patterned cut patterns (341)(346) enabling relatively fast separation of the resulting corrugated preform structure (158) along the parting lines (157) in the consequent parting operation.

Turning now to the specification of the pre-patterns, such pre-patterns will be generally formed on the preferred foil layer while the layer is disposed in a roughly planar form, preferably by unwinding a roll of the layer material. The planar designs of the pre-patterns are accordingly specified, in FIGS. 8(b-c), in terms of the previously defined metrics describing the embodied frustum core structures (142).

In accordance with the layered winding process of the preferred embodiments, a specific tab-separated pre-pattern, in either the “linear-cut” pre-pattern (346) or the “angular-cut” pre-pattern (341), will correspond to one single layer (one of a, b, c, or, d) in the embodied preform, since each corrugation layer and each interfacial layer will preferably incorporate a dimensionally different pre-pattern having adjusted dimensions in accordance with the distinct Lₙ, sₙ, and sₙ₊₁, of each corrugation layer.

With regard to the interfacial foil, a periodic linear array of linear cuts is formed in the preferred aluminum foil layer, wherein, in particular, a small rectangular piece/section (363) of the interfacial foil stock (344), in FIG. 8(b), with the linear pre-pattern (346) formed therein, is pre-patterned by the preferred laser cutting embodiments. Since the interfacial aluminum foil layers (163) of the preferred embodiment comprise a linear sectional profile, in FIG. 4(b), of constant width, Bₙ, in accordance with the embodied cylindrical shape of the preform's (and each resultant frustum core's) interfacial layers, the corresponding linear strips (163) in the linear pre-cut pattern, in FIG. 8(b), also have a specific constant width, Bₙ, that is the corresponding width Bₙ of the interfacial foil (163) interfacing one layer's corrugated media (148), in FIG. 4(b).

In the preferred embodiment, corrugation precedes winding of the corrugation foil stock (344) onto the preform under construction. Similar to the interfacial foil stock, it is preferred that the corrugation process is preceded by an “angular-cut” pre-patterning stage, wherein the aluminum foil to be corrugated is first laid flat and patterned with a periodic array of cuts that are alternately in parallel and oblique orientation to the corrugation foil stock's feed direction, such that this “angular-cut” pre-pattern (341) corresponds to the desired edges of the corresponding corrugation layer (a, b, c, d, in figures), where these edges comprise the inner and outer surfaces-of-revolution (170) (171) of the resultant, parted, frustum-shaped core structure.

In particular, specific attributes of the “angular-cut” pre-pattern (341) are set-forth in a pre-patterned rectangular piece (364) of aluminum corrugation foil, in FIG. 8(c). Similar to the “linear-cut” pre-pattern (346) of the interfacial foil stock, a pattern of tabs are formed in the “angular-cut” pre-pattern (341) so as to maintain a precise alignment between tabbed sections of the patterned foil during subsequent corrugation, winding, and parting processes.

In accordance with the preceding description, angled-line features (359) of “angular-cut” pre-pattern (341) in the flattened-state corrugation foil define the sidewall portions of the resulting corrugation layer in the embodied frustum core structure (142); and, straight-line portions (360) of the “angular-cut” pre-pattern (341) in the flattened-state corrugation foil, in FIG. 8(c), running parallel to the feed direction accordingly define the ridge-surface segments (353) (354) of the resulting corrugation layer as it is formed in the wound preform.

Since a portion of each corrugation layer, namely, the upper ridge surface (353) and lower ridge surface (354), are portions conforming to the cylindrical, constant-height, interfacial layers (163) of the first preferred embodiments, such sections of the “angular-cut” pre-pattern (341) are accordingly linear sections (353) (354) in the flattened stock being pre-patterned, as well, in FIG. 8(c).

More particularly, in its planar form, the “angular-cut” pre-pattern (341) has angled segments (355) that are the side wall segments (355) in the frustum core structure. These sidewall segments are accordingly formed with angled profile to also provide the slanted profile and resulting axial displacement Jₙ of the opposing ridge structures, with respect to one another, once these segments are parted into the corrugated structure of the embodied frustum core. Therefore, planar displacement angle σₙ providing the same displacement Jₙ, in FIG. 4(b), is specified, where the angle σₙ is fully defined by basic Pythagorean geometry, by the predetermined linear dimensions. Accordingly, σₙ=tan⁻¹[Jₙ/Lₙ] and angled cut length (558), lₙ=(Jₙ²+Lₙ²)^{1/2}. Furthermore, the edge length (558) of angled cut edge (359) where length is set by defined variables as hypotenuse, as defined by quantity [Jₙ²+Lₙ²]^{1/2}, in accordance with basic analytical geometry.

Distance (549) between first bottom fold axis (551) and second bottom fold axis (553) defines the lower ridge-surface arc-length, sₙ, in the resultant frustum core. Distance (550) between first top fold axis (552) and second top fold axis ((555) defines the upper ridge-surface arc-length, sₙ₊₁, in the resultant frustum core. Distance (557) between first bottom fold axis (551) and first top fold axis (552) defines side-wall length Lₙ of the side-wall segment, in the resultant frustum core.

It will be further appreciated that, in the “angular-cut” pre-pattern, the upper ridge surface (353) and lower ridge surface (354) of a single corrugation strip (i, ii, iii, iv, . . . ) are accordingly displaced from one another by the distance Jₙ, where n=1, 2, 3, . . . etc., for each concentric layer of corrugated media in the frustum core structure (142), and where distance Jₙ is identical to its respective displacement Jₙ in the embodied frustum core structure, in FIG. 4(b). It will further be appreciated that the constant width of the pre-patterned ridge surfaces (353) (354) is the same as the axial depth Aₒ of the interfacial layer (163), in FIG. 4(b). The distance between adjacent ridge surface sections of the same corrugation layer, will be connected by sidewalls having the length, Lₙ, as defined in FIG. 6(a-b), and accordingly, is the distance (557), designated “Lₙ”, between first fold axis (551) and second fold axis (552) in FIG. 8(c). As the values of Jₙ, Bₙ, and β, are selected according to the desired geometry, the length, Lₙ, will become fully defined once a desired constant ratio of the sub-component angles, δ/α, is selected.

As indicated, the distance (545) between opposite edges of the same ridge-surface in FIG. 8(c), is preferably identical to the identically oriented axial depth, Aₒ, of the interfacial layers (163), in FIG. 8(b) and FIG. 4(b), to which the ridge-surfaces are adhered, in the resultant frustum core.

Also in the “angular-cut” pre-pattern (341), top ridge-surface rear axis (547) is coincident with top ridge-surface's external edge, and, bottom ridge-surface rear axis (548) is coincident with bottom ridge-surface's external edge, where both external edges will form part of the frustum core's external conical effective surface-of-revolution (171), which in turn, interconnects to the facing external cladding layer (162) in the embodied conical concentrator (80).

Accordingly, in the flattened-state corrugation foil, planar distance (546) between the top ridge-surface rear axis (547) and bottom ridge-surface rear axis (548) is identical to the axial displacement Jₙ, between bottom ridge-surface (353) and top ridge-surface (354), in FIG. 4(b), wherein this variable is embodied variously as J₁, J₂, J₃, J₄, in the exemplary preferred embodiment.

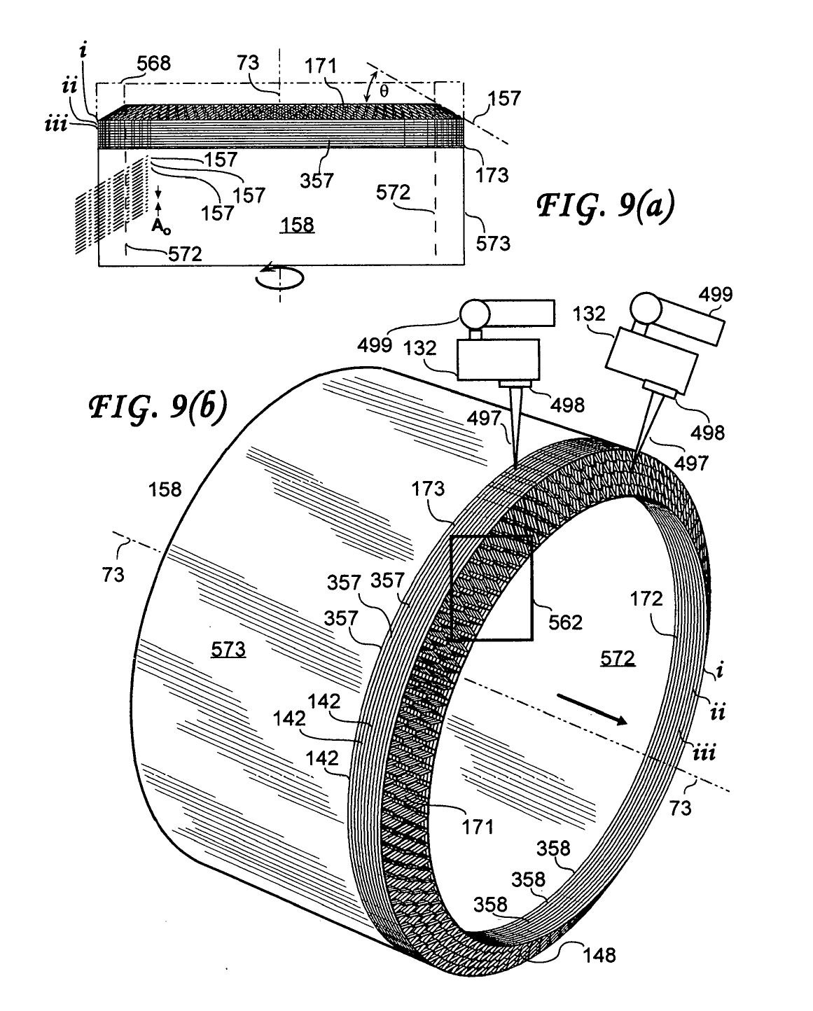

Since the aluminum foil (144) in the corrugated aluminum supply-roll (343) is ultimately formed into the corrugation layers disposed in the frustum structures disclosed, the “angular-cut” pre-pattern (341) is characterized by cut lines that will be coincident to the respective surface-of-revolution (170) (171) with formative parting profile (157), in FIG. 9(a-b). In the final parting stage, the effective parting-cut profiles (157) are executed by means of cutting through tab features (368) so as to separate each consecutive frustum structure. Accordingly, the foil (144) of the corrugation aluminum (343) supply roll is corrugated before winding, so as to possess the characteristic fold lines of the disclose corrugated structure. Accordingly, the laser-cut angular pattern (341), in FIG. 8(b-c), is predetermined and monitored so as to be corrugated by the corrugation means providing the specified placement and indexing of the fold lines (or brakes, creases) in the corrugated structure.

In accordance with the preferred honeycomb-like media profile, which may incorporate either roughly hexagonal cells, in FIG. 5(b), or the preferred hexagonal half-cell structures with interfacial layers (163), in FIG. 5(a), the pre-patterned corrugation foil (343) is formed so as to be bent by the embodied corrugation means along axes, or fold lines, such that the corrugation surfaces of the embodied corrugation layer thereby result. Accordingly, the parallel fold lines (551)(552)(553)(554)(555), in FIG. 8(c), define the side-walls and ridge surfaces of the resulting corrugated foil media, in a manner similar to the identically labeled, parallel fold lines of generic corrugated media, in FIG. 1(a).

Two fold lines (554) (555) define a repeated spatial period (556) of the “angular-cut” pre-patterned material (the spatial period, here, determined from the fold-lines, rather than from the ridge-surface centerline). Similarly, as the “angular-cut” pattern (341) is subsequently corrugated along the fold lines as described, the repeating periodic length (556) in the planar form is consequently shortened to a corresponding corrugated arc-length, Pₙ, once it is subjected to the corrugation process and then wound onto the embodied preform to form a corresponding corrugation layer. In the planar form, in which form the “angular-cut” pre-pattern is preferably formed, this periodic pattern that is cut into the flattened-state corrugation foil, as measured in the feed direction, has the dimension, 2Lₙ+sₙ+sₙ₊₁, in FIG. 8(c).

In both of the embodied pre-patterns (341)(346), the pre-pattern cut-width dimension (544) in linear portions of the pre-cut patterns, defines the separation between tab-connected edges of adjacent frustum core structures (i, ii, iii, iv, . . . ) in the preform structure (158) prior to parting operations. This cut width is, preferably, roughly the same in both pre-patterns (341) (346), wherein it is preferably minimal, and is preferably made in range of micrometers to a millimeter, depending upon precise pre-patterning method.

The linear and angled cuts of the pre-cut patterns (346) (341), in FIG. 8(b-c), preferably have a minimal width, approximating the minimal material removal associated with a slitting operation. Acceptable results may be realized with a wide range of cut widths, though width of laser-cut slit (544) can be expected to be reliably and reproducibly achieved at line/cut widths on the order of 0.0001-0.010″ or, 2.5 to 250 micrometers, though larger/smaller cut widths are contemplated, and readily achieved by current laser-cutting methods.

In accordance with a primary objective of the present invention, which is to accelerate production and throughput of the embodied conical-frustum concentrators by means of patterned cutting of the preform material prior to the embodied parting operation, the embodied pre-patterned, laser-cut foils are maintained intact and contiguous in the winding operation by means of interconnecting tab features (368) that inter-connect adjacent laser-cut sections in the pre-patterned aluminum-foil stock, in FIGS. 8(b-c), so that the rolled foil stock substantially retains its original form prior to and after being wound onto the preform under construction.

In accordance with the otherwise straight edge profiles (365) (360) in the immediate vicinity of the tab features (368), in FIG. 8(b-c), the tab features are defined as that physical material which lies within the cut width (544) and therefore interrupts the immediately surrounding linear cut profile, where the surrounding linear cut profile comprises opposing edges of adjacent, interconnected sections (i, ii, iii, iv, . . . ) of the pre-patterned foil, separated by linear cut width (544). Whereas tab locations may be located randomly, anywhere along the pre-cut pattern, it is preferred that the tabs be located at regular, radial geometric locations, so that the embodied laser removal process is able to execute in a time-efficient and reliable manner.

In the pre-patterned foils, in FIGS. 8(b-c), the pre-patterned laser cut marks are spatially interrupted by a series of tab features (368) of a pre-determined width (540) wherein the width is structurally adequate for maintaining spatial orientation of the cut sections in the preform until the preform undergoes the embodied parting operation. As such, tab widths (540), in FIG. 8(b-c), of around 250 micrometers is generally sufficient, though considerably less or greater tab widths may be advantageous, depending upon the specific size and detachment process. For example, tab widths of several millimeters may be found preferential for robust handling capability under greater process variation; or, alternatively, many, more closely spaced small tabs of 100 micrometers or less could allow a parting stage that is simply executed through applying a force to tear the tab features, in a manner analogous to intermittent detachable tab features used in pre-cut cardboard/paper cut-outs in the packaging industry and elsewhere.

In the linear, tabbed, pre-cut pattern (346) formed into the interfacial foil supply stock, the distance (541) between connecting tabs features (368) is preferably that resulting in the interfacial aluminum foil (163) having tabs position at the same angular period as that of the corrugated foil, once incorporated into the preform (158), where tab spacing is accordingly resulting in a spacing of Pₙ in the linear pre-pattern, or alternatively, Pₙ/2, such that, accordingly, the tabs in the interfacial foil and in the corrugation layers will be centered at the intersection of the radial center-line axes (465) with the interfacial layers (163) and coincident interfacial surfaces (464). As a result, the tabs are readily accessed by cutting lasers of the parting operation, as later indicated in the parting operation of the preferred embodiments. An average width, or radius (560) of tab removal region (567), in FIG. 8(b-c), may have various aspects, but is preferably a measurable egress into the otherwise straight surrounding edge profile. These removal regions preferably coincide roughly with the centerline axes, so that laser beams may be directed to these regions, as indicated by arrows (454) pointing to the tab removal regions in FIG. 6(b); though, alternatively, tabs may be located in rough coincidence with the corrugation axes (576).

In accordance with the embodied corrugation layers, and with the parallel orientation of their associated corrugation fold-lines (552) (553) (554)(555)(556), the angled side-wall segments (355) of the corrugation layers (148) are planar segments that are parallel to the central axis (73) of the conical frustum.

As will be understood by those skilled in the art, and as is commonly introduced in standard texts in analytical geometry, the curved line formed by intersection between a plane and a conical surface is widely referred to as a “conical section,” wherein lines of intersection between conical surface and variously oriented planes provides alternately the geometric definition of a parabolic, elliptical, and hyperbolic curve. Accordingly, it is well-known that the conic section of a plane that is parallel to the central axis of the intersected conical surface defines a hyperbolic curve. Therefore, the most highly accurate form of the formed edge profile (359) of the side-wall segments (355) is actually a very slight hyperbolic curve, if the parted side-wall edges of the frustum core structure are to conform precisely to the intended, conical, surfaces-of-revolution (170(171), in accordance with the side-wall segment (355), since the latter is, by its definition, coincident to some conical-section plane (561), in FIG. 5(a) that is parallel to the central axis (73).

In practice, the hyperbolic displacement (559), or sagitta, or “sag” of the ideal hyperbolic edge profile (369) from nominally linear side-wall edge profiles (359), in the present invention, in FIG. 8(c), will typically be less than 25 micrometers, which is substantially smaller than what can typically be visibly differentiated in a planar view figure, and also smaller than the nominal tolerances typically encountered in most high-throughput laser-cutting processes, which are typically not better than +/−0.001″. The displacement (559) of hyperbolic profile (369) is thus greatly exaggerated in its non-linear aspect, in FIG. 8(b), so as to be viewable in the figure.

Accordingly, the embodied hyperbolic displacement of each individual side-wall edge, whether present or not in the 3D CAD model and associated tool-path of a fabricating tool, will typically have no discernible impact on the resulting structure; however, in practice, it is far easier to have the precise hyperbolic displacement already included in the model utilized, since generating these precise dimensions will be automatically generated in the process of generating the embodied surface-of-revolution in the preferred commercial 3D CAD software, which is, again, the most straightforward and preferred method. Accordingly, the hyperbolic curve of sidewall edges (359) is preferably extracted directly from numerical computations imbedded within the preferred commercially available computer programs providing 3D modeling, such as provided by Solidworks, Pro-E, CATIA, etc.

Alternatively, the hyperbolic displacement can be readily assessed by basic analytical geometry, where the displacement is preferably assessed as a hyperbolic curve according to its well-known formula,

(y²/a²)−(x²/b²)=1

with the conventionally defined constants, as assessed in the coordinates of the sectional plane, where y is parallel to the frustum's central axis (for example, see H. Anton's “Calculus with Analytical Geometry”). In this less-preferred analytical approach, for example, the side-walls of one specific corrugation layer, such as the outer corrugation layer, d, in the preferred embodiments, will each be coincident to a specific plane (561), wherein, in accordance with the determining characteristic angle, φ₄, of this layer, the characteristic plane (561) of all side-walls in the corrugation layer is thus specified by a constant distance, D_{sect}, in FIG. 5(b), from the central axis (73) as determined by φ₄. Accordingly, since the frustum core's surface of revolution is represented by a cone of specific angle, θ, and this cone is intersected by a plane parallel to the central axis and displaced by distance D_{sect}, the hyperbolic curve, of which the desired sidewall edge is a coincident segment, is thus fully defined by these selected values θ and D_{sect}. Since, in the relevant right cone and sectioning plane of this corrugation layer, “d”, it may be seen that R₄ and R₅ uniquely specify the precise points along the defined hyperbolic curve, between which lies the curved segment that represents the desired curve of the sidewalls of this example corrugation layer, “d”, and hence the curve of this side-wall edge, in the “angular-cut” pre-pattern (341) is thus fully specified by graphing this particular segment of the specified hyperbolic curve in the characteristic plane (561), between these two conical radii, R₄ and R₅. In the present alternative embodiment for obtaining such hyperbolic dimensions, this graphing of the hyperbolic edge-profiles can similarly be performed for each corrugation layer of a desired frustum. The coordinates of the plane are accordingly set up for each individual corrugation layer. Such alternative, analytical, methods are generally considered herein as unnecessarily laborious, and less-preferred relative to the preferred 3D CAD methods embodied.

In certain embodiments wherein micrometer-scale precision is needed, or, where relatively large angular periods, β, are desired, such hyperbolic edge profiles can be readily generated by commercial 3D CAD programs and subsequently transferred to commercial laser machining tool-path software of widely available NC controlled machining centers, where the needed precision can be physically realized through commercially available pulsed fiber lasers, particularly those in the shorter pulse regimes, such as in the pico-second regime; and, further, through utilizing wavelengths on order of a couple micrometers (e.g. YAG at 1064 nm) or less (e.g. frequency-doubled Ti:sapphire, Ar lasers, excimers, etc). While these precision levels are contemplated for the large solar concentrators embodied, the cost-benefit ratio may be particularly more attractive for alternative embodiments wherein electromagnetic communications, such as IR, micro-wave, or radio-wave applications are pursued. Alternatively, such micron-scale accuracy may also provide added mechanical strength, with greater strength-to-weight ratio, in high-value pay-loads or when utilized in various aerospace applications, where exceedingly thin media may be utilized, and such precision has a desired benefit.

It will be appreciated that the pre-patterning of the present invention need not be formed in-line with the preform fabrication process, since standard unwinding and winding equipment utilized in the converting industry may be utilized in a separate, preceding stage, wherein the stock foils, in either the case of the interfacial foil or corrugated foil, are laser-cut with the disclosed pre-patterns, in such a separate unwind/wind stage. In such alternative embodiments, pre-patterning lasers of the embodied winding process, in FIG. 7, would instead be utilized in the separate pre-patterning operation, so that rolled stock of the embodied winding process will alternatively already be completely pre-patterned on their respective rolls (343) (344). Alternatively, such separate pre-patterning processes that produce the embodied pre-cut patterns may be contracted out to the foil supplier, since foil suppliers commonly provide laser cutting/patterning services.

As in previous embodiments of the related patent applications by same author, the cylindrical wound preform (158) produced by the presently disclosed methods is subsequently parted, so as to be separated into a series (i, ii, iii, iv, . . . ) of individual frustum core structures (142) of the preferred embodiments, thus producing a plurality of cores for fabricating an equal number of the embodied conical concentrator (80). In accordance with such previous embodiments, a parting operation is utilized, in FIG. 9(a-b), that separates the preform into the embodied multitude of constituent core structures (142) each having form of the embodied right conical frustum core, wherein it is required that the various structural components of the preform be separated along the surface of revolution defined by the linear parting line (157) that effectively defines the resulting conical surface of the frustum-shaped core material, where the surface-of-revolution is defined by the surface generated when a defining linear parting profile (157) is rotated about the central axis (73), regardless as to the precise nature of the physical parting means.

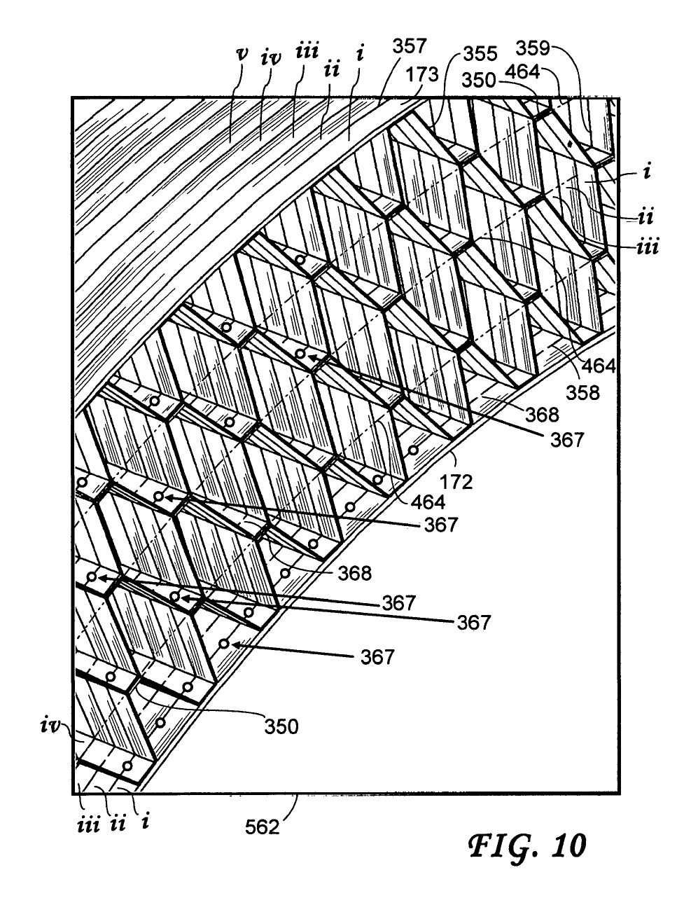

As in the previous embodiments, the preferred interfacial layers (163) are omitted, in FIGS. 9-10, so as to more clearly point out the embodied parting operation. The preform (158) being processed in the embodied parting operation is depicted in a partially processed form, such that the removed portion (568) of the preform, in FIG. 9(a), has been previously parted so as to reveal the top-most cut surface of the exposed core structure, which is accordingly terminated at one of the embodied surface-of-revolution parting cuts that define the parting operation, where more particularly, it is preferred that the parting cuts (along previously formed pre-pattern cuts) are executed at the end of the preform that leaves the external surface (171) of the following top-most frustum core (142) in the parted series that yet remains incorporated in the preform. However, the parting cuts may be readily executed from either end of the embodied, tube-shaped, preform.

In accordance with the laser-formed pre-patterns disclosed in conjunction with FIGS. 7-8, the finished preform can subsequently be separated into a sequence of the resulting frustum-shaped core structures by means of removing the embodied tab features (368), which interconnect adjacent frustum-shaped core structures within the pre-patterned preform.

In the preferred embodiments of the present invention, the parting operation is executed through tandem laser-cutting operations, wherein, preferably, focused pulsed-fiber lasers are translated about the preform so as to cut through the previously embodied tab features (368) that interconnect constituent frustum core structures along the described separation surfaces formed by linear cut profiles (157), at which surfaces the preform is accordingly parted to form the parted opposing conical surfaces (170) (171) of adjacent conical frustum cores. A preferred process and assembly, in FIG. 9-10, executes the preferred laser-parting process.

As in previous embodiments incorporating a cylindrical inner-edge-surface structure (172) and/or cylindrical outer-edge-surface structure (173) in the finished frustum shaped concentrator, the embodied parting operation accordingly requires cutting of the preform's inside and outside edge-surface structures (572) (573), as well as cutting of the corrugation layers residing in the annular space disposed between these edge-surface structures, wherein such cutting is accordingly performed so as to form the surface-of-revolution defined by the rotated linear cut profiles (157).

The successive parting-line profiles (157) are positioned incrementally along the central axis (73) where axial spacing between parting lines (157), in FIG. 9(a). is accordingly equivalent roughly to the axial depth Aₒ, wherein the axial spacing between these parting lines is further adjusted by any material loss due to the cut width (544) in FIG. 8(b-c).

The parting operation is preferably realized by rotating and translating the cutting means about the central axis (73), though may alternatively be realized by rotation of the preform about its central axis, as in previous applications, or by any appropriate combination of motions adequate for the embodied laser-based parting of the cylindrical, tubular, preform.

In accordance with the preferred embodiments, parting of each frustum core is performed sequentially by means of removing all tab features disposed along the specific parted frustum's surface-of-revolution to be parted, located at the processed end of the embodied preform, in FIGS. 9-10, before proceeding to parting of the next frustum core in the series (i, ii, iii, . . . etc.). It is preferred that the tabs are cut by laser means, and more preferably, that the laser means access the tabs by means of being directed onto the tab removal regions (367) through the front side of the frustum core that is still integral to the preform and in the process of being parted, in FIG. 9(a-b) and FIG. 10.

Accordingly, if a series (i, ii, iii, iv, etc) of identical frustum cores is being removed from a preform (in FIG. 9-10, midway through the preform parting process), a laser scanning head will be directed to first remove the layer of tab features, in FIG. 10, that correspond to the interface between the top-most frustum core (i) and underlying frustum core (ii) of the preform being subjected to the parting process, wherein the tab removal regions (367) each designating tab features (368) of the parting interface are indicated by small circles, in FIG. 10. Once all tab features interconnecting these two constituent frustum cores of the preform are removed, the top-most core (labeled ‘i’) is translated axially, preferably by mechanical robot means, away from the processed preform, so that the tab removal process can be repeated for the next core structure (labeled ‘ii’), in FIG. 10. It will be understood that this parting process can be iterated sequentially until the preform is completely separated into its multitude of constituent frustum core structures.

Whereas the frustum cores may be parted from either the, roughly speaking, concave or convex side of the parted sequence of frustum cores, it is preferred that the preform be parted from the roughly convex side of the constituent frustum cores, corresponding to the external surface (171), in FIG. 9b. In this way, the lasers may be positioned about the periphery of the preform, while being provided clear paths to the tab features of the frustum core being parted from that end of the embodied tubular preform (158) being parted.

Whereas the preform may be rotated about its central axis during the sequential removal of the tab features, it is more preferred that the laser robot means (499) be capable of rotating the laser scan heads about the preform, so that separation of the preform structures may be performed independently at maximum speed consistent with the parting speed enabled by the tandem lasers. It will be understood by those skilled in the art that mechanical means for rotating and translating the manufactured articles are well-established and readily available from any of a wide range of vendors worldwide.

In an alternative preferred embodiment, such relatively straight-forward, circular, edge-surface cuts, in the cylindrical outer and inner surfaces (572) (573) of the preform, may be formed via the embodied route of first forming removable tabs in the edge-surface structure similar to those preferred in the case of the concentric interfacial layers (163), in FIG. 8(b). It is typically more preferred, though, that such circular cuts on the outer and inner cylindrical surface of the preform be implemented with a separate laser (or a separate set of tandem laser heads) that preferably utilizes relatively short focal-length optics that can efficiently perform precise and continuous cutting at speeds on or approaching the order of meters/second, so that these edge-structure separation cuts are thus readily performed in the parting stage with no resulting tab-removal features. In such preferred cases, the winding, specifically of the edge-surface structures, will be performed without the embodied cut pre-patterning of the stock foil.

In the first preferred embodiments, laser-formed separation cuts in both outer and inner edge-surface structures (572) (573) are preferably continuous cuts. These cuts comprise outer, laser-formed, continuous separation cut (357) between adjacent frustum-shaped core structures thereby sequentially separating the corresponding multitude of outer edge-surface structures (173) of respective frustum core structures (142); and, similarly, an inner laser-formed separation cut (358) is formed between adjacent frustum-shaped core structures separating the corresponding multitude of inner edge-surface structures (172) of respective frustum core structures (142). Also, it is preferred that these edge-cuts be cut with fiber laser means separately addressing inner and outer edge-surface structures, wherein the edge-surface cuts are made uniformly through all layers of the preferred multilayer edge-surface structure, in FIG. 9(b).

As is explained in conjunction with the embodied parting operation, the resulting, frustum-shaped, core structures (142) are parted from the preform by means of removing the embodied tab features that interconnect adjacent core structures, wherein such removal preferably comprises removal of material contained within a roughly predetermined outline region (367) for laser-cut tab-removal, such that the resulting material removal, in a particular tab removal, will typically result in a tab-removal edge-feature, after laser removal, that preferably is distinguished by a localized, somewhat recessed edge-profile feature in the corresponding edge that is otherwise conforming to the surface-of-revolution (170)(171), indicating greater material removal than that strictly limited to the previously defined tab feature (368).

The laser focal target/removal region (367) will, in the laser-parting operation, in FIGS. 9-10, preferably comprise material removal from the full region (367), which, of course, includes all material that comprises the interconnecting tab structure (368). Alternatively, the laser-removed material ultimately removed in the removal region may be strictly equal to that material which, when removed, results in via walls of a cut trench/via that is indiscernible by any means from a continuous laser-cut line, or, severing the tab may result in some remaining tab material, in less preferred embodiments.

However, in the preferred embodiment, it is preferable to remove slightly more material in the tab-removal process, so that there is no possibility of remaining material protruding outside the surrounding edge. Accordingly, it is preferred that the material removed in the regularly spaced tab-removal regions correspond to enough material removal so as to result in the removal region having at least several micrometers of recess feature in the otherwise singular profile of the cut edge. Since these edge profiles, formed in the cut pre-patterns (341)(346) and the subsequent tab removal, together form the interior surface (170) and exterior (171) surface of the frustum core structure, the precision of which determines the precision of the contacted reflector layer (161), external surface layer (162), and resultant concentrator, such small indent features allow faster processing while retaining high precision, where discrete recess features in the cut edges will result in resin readily bridging these recess features during application of cladding layers (161)(162).

As is conventional with corrugated foil and honeycomb hollow-core structures of the prior art, the aluminum foils utilized in the hollow core media herein will have thickness' ranging from the thinnest that are made and utilized structurally (around 10 micrometers) to sheet metals greater than 500 micrometers. Preferably, thickness of the foils utilized are in the thickness region of commercially available foils and strip, wherein, preferably, these sheet material thicknesses are between 10 micrometers and 250 micrometers, and more preferably, in the primary solar applications of interest, corrugated portions of the core media incorporate foils in the range of 12 micrometers to 200 micrometers. Use of less preferred media such as impregnated papers or plastic films may advantageously have thickness ranges far outside this range.

In the embodied laser-assisted parting operation, the focused laser beam (497) is produced by laser's scan head, typically by means of a theta lens (498) or equivalent, preferably utilized for focusing the laser while providing a suitably sized imaging plane. Accordingly, the laser beam is processed by steering optics that provide computer-controlled scanning of the focused laser beam, wherein such scanning capability is commercially provided in the form of fully integrated, computer-controlled, gimbal-steered, laser scanner-head packages, such integrated packages provided by numerous companies such as Rofin, Scan Labs, Keyence, etc.

It is preferred that each of the lasers of the present invention be mechanically positioned by means of a robot (499), which is preferably a modern, numerically controlled, commercially available, multi-axis robot of the type typically utilized for laser welding and cutting, as available from commercial robot makers such as Kuka, ABB, Yaskawa, Fanuc, etc.

While the positioning robot is capable of providing translation of the laser beam to all positions required for material removal, it is preferred that the steering optics of the laser scanning head provide much of the beam steering necessary for articulation of precise cutting operations required, whereas the robot is utilized for the more global placement requirements, as is commonly practiced in the laser cutting field.

It is preferred that the embodied tab-removal process utilize laser scan heads of relatively long focal lengths (>10 cm) to minimize mechanical positioning requirements of the robots, as well as to reliably access the various tab-features with sufficiently narrow focused-beam cones. In the case of utilizing remote laser cutting (RLC), wherein focal distances may be on the order of one meter or more, then tab-removal cut widths may be relatively larger, on the order of millimeters. Such latter cutting means may be utilized, particularly in the parting operation, while still maintaining comfortably adequate dimensional control. The precise cut width utilized will also be a function of the precise rolled media utilized, as its dimensional stability and ability to be maintained within a certain depth of focus will also determine the choice of beam processing, wherein these requirements are readily accommodated by commercially available scan-head packages. Also, since a great variety of lasers and operating conditions will provide adequate laser-cutting characteristics, depending upon precise circumstances, materials, and requirements, the cut width (543) of the pre-patterns will ultimately depend upon the precise structure being fabricated and optimum throughput, therein determining type of laser utilized, wavelength, pulsed waveform shape (or possibly, continuous wave operation), frequency, and average power.

In the first preferred embodiment, the tabs are removed by pulsed, fiber-based lasers having pulse widths in the nanosecond range or shorter, preferably having greater than 100 watt average power level, available from such vendors as IPG Corp, SPi, Trumph Gmbh., etc. Alternatively, other lasers may be utilized, such as solid state disk lasers utilizing YAG or other solid state host media, gas lasers, dye lasers, “direct diode” cutting lasers, or any suitable lasing source. Alternatively, removing these tabs may be accomplished by any appropriated means utilized in the prior art for cutting or slitting foil, including any variety of slitting blades, saws, water jets, EDM, particle abrasion, and so on. In an alternative embodiment, using appropriately reduced, readily detachable, tab widths, it is also possible that the separation process be performed through application of well-defined forces so as to mechanically tear through each tab, though this is less preferred.

With regards to beam-processing optics of the lasers utilized in the disclosed step of tab removal, galvanometric steering optics of the type utilized in remote laser cutting (RLC) may be utilized, so as to provide fast access to each of the tab locations, which are accordingly programmed into the tool path of a robot that is manipulating the laser scanning head. It is preferred that some form of programmable, numerically controlled, dynamic focusing be utilized so that the z-axis (focal distance) location of the pulsed laser beam-waist can be quickly altered without a commensurate movement by the robot. For example, large-range variation of focal distance may be programmed by such means as the programmable focusing optics offered on Trumpf “Trudisc” lasers, which are amenable to several tandem laser heads from one central lasing unit. In this parting operation, several fiber-fed laser heads operating in tandem can thus enable parting times on order of several seconds per frustum core.

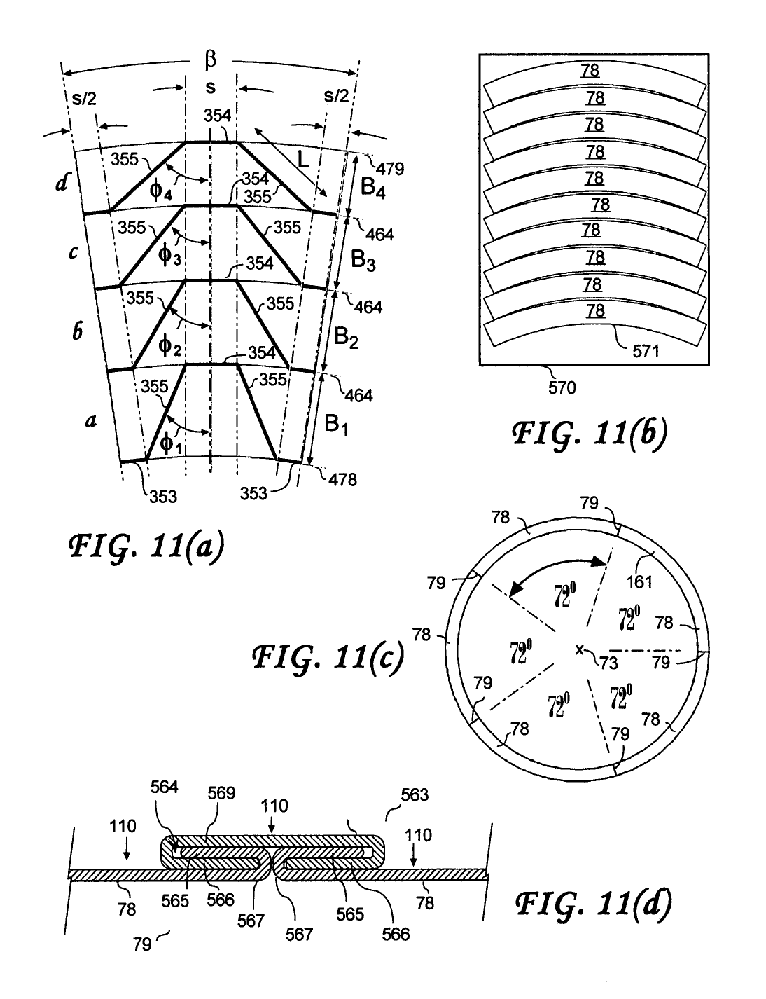

In contrast to the first preferred embodiment, wherein corrugation layers possess different segment lengths and angular relations that are determined for greater control of side-wall angles and optimization of strength-to-weight ratio, there is also disclosed herein an alternative preferred embodiment, in FIG. 11(a), that is specifically advantageous for very high throughput and low-cost, wherein the embodied adjustment of spatial periods for the corrugation wavelength in each consecutive, adjacent corrugation layer of the preform may be accomplished through tensioning substantially identical corrugated material in a pre-determined manner, so as to stretch the corrugation period as it is rolled upon the preform, thus providing a different corrugation waveform of different layer thickness, Bₙ, at each layer, thereby also providing the preferred radial symmetry.

Accordingly, in contrast to the first preferred embodiments, as detailed in FIG. 6(b) and FIG. 7(b), the present alternative embodiment does not possess a constant ratio δ/α, but instead utilizes a constant linear length of material. Thus, in the present alternative embodiment, the length of corrugation foil forming each corrugation period of multiple corrugation layers (layers a, b, c, d), is a constant, K_{c}, where:

K_{c}=2Lₙ+2sₙ=2Lₒ+2sₒ

Such alternative preferred embodiments are particularly advantageous for the preferred condition of smaller cell dimensions wherein the hyperbolic displacement (559) is negligibly small; and, its variation, due to varying side-wall angles, is effectively negligible.

In present alternative embodiment, the corrugation layers are represented as having all upper ridge surfaces aligned on one respective radial axis and all lower ridge surfaces aligned on one respective radial axis, similar to the alternative preferred embodiment of FIGS. 1-2, where this orientation is displayed for the purpose of describing the incremental modification of each corrugation layer, relative to its adjacent corrugation layer. It will be readily understood that, as is described in the first preferred embodiments, in FIGS. 4-10. the structure of FIG. 11(a) can readily be modified so as to have every other layer inverted, or equivalently, shifted by one-half of the embodied waveform for that corrugation layer, such that the same geometrical relationships of individual corrugation layers as disclosed in conjunction with FIG. 11(a), is constructed with the layers b and d rotated one-half of a corrugation wavelength, about the central axis (73), so as to form the paired, opposing corrugation layers having ridge-surface unions (350) uniformly aligned on centerline axes (464), in the honey-comb-like structures as defined in conjunction with the preferred embodiments, in FIGS. 4-10.

In the present alternate preferred embodiment, the ridge surfaces (353) (354) are again spatially oriented so as to mutually align on a series of radial, ridge-surface centerline axes (465), thereby delineating a regular angular period about the central frustum/preform axis (73). In this way, removable tab locations are preferably, again, also remaining centered on these radial centerline axes, as viewed along the direction of the frustum central axis (73).

In the present alternative preferred embodiment, defined sidewall stretch angles, ϕₙ, define the stretched and set angle between sidewall (355) and its adjacent ridge-surface centerline axis (465) in FIG. 11(a), and will be noticeably different in each consecutive layer (a, b, c, d) of the frustum core structure, and more preferably, this angle will be measurably greater at each adjacent corrugation layer of greater radius. Equivalently, this pattern of increase in angle ϕₙ will result in condition: ϕ₂ of layer b will be greater than ϕ₁ of layer a; ϕ₃ of layer c will be greater than ϕ₂ of layer b; ϕ₄ of layer d will be greater than ϕ₃ of layer c. Also, in this same alternative preferred embodiment, in FIG. 11(a), it is preferable that the following conditions hold:

B₁>B₂>B₃>B₄;

ϕ₁<ϕ₂<ϕ₃<ϕ₄; and,

J₁>J₂>J₃>J₄

wherein the, non-constant, axial displacement Jₙ is otherwise defined as previously, in FIG. 4(b).

In the present alternative embodiment having constant running length of material in each concentric layer, the specific design of a preferred frustum core-structure is preferably arrived at through constructing the frustum core structure in a solid modeling programs, such as Solid Works, Pro-E, Catia, etc, since this method provides means for readily arriving numerically at the precise solution desired, where this would typically be done through first setting the desired over-all dimensions of the frustum structure (80), and then implementing the embodied constraints; namely, a constant side-wall dimension, wherein L₀=L₁=L₂=L₃=L₄, and, a constant ridge-surface arc-length dimension, wherein s₀=s₁=s₂=s₃=s₄, in FIG. 11(a), which again correspond to the ridge-surface segments (353)(354) in the present alternative embodiment. Given these limitations, conventional 3D modeling software will then numerically solve for the various Bₙ, Jₙ, and ϕₙ with some limited degree of freedom in the relative proportions, such as in the limited range of angles allowed for any group of solutions.

One may, alternatively, create an equal, identical length of corrugated material for each of the corrugation layers of the frustum core, and thereby estimate the end radius Rₙ₊₁, of the last corrugation layer made through this approach. One would estimate the first wound layer of corrugated material, for a preferred first-layer side-wall angle, ϕ₁, followed by stretching an identical length of identically formed, unwound, corrugated foil for each layer of the preform, wherein each consecutive layer (a, b, c, d) is subsequently tensioned incrementally more than the underlying corrugation layer, so as to precisely match the opposing terminated ends of each identical length at each consecutive, concentric layer of the preform, thus resulting in the essential, radially symmetric, structural attributes of the present embodiment, in FIG. 11(a), wherein an identical number of corrugation periods is disposed in each corrugation layer; and, where again, corrugation layers may be disposed in alternating fashion so as to provide the earlier joined ridge surface unions (350) of earlier embodiments.

A third less preferred means for realizing the alternative structure, in FIG. 11(a), is through analytical means. In an analytical approach, the angle and outer radius of each corrugation layer is, practically speaking, calculated based upon the outer radius of the underlying corrugation layer, where the finished outer diameter of the underlying corrugation layer determines the inner diameter of the subsequent corrugation layer, and so on.

Accordingly, in this last alternative approach, the desired angular period, β, and desired inner diameter R₁, and the desired number of corrugation layers of the preform, are first selected. Secondly, the first corrugation layer, “a”, is designed according to the specifically desired structure dimensions, with an adjustable angle in the range desired. Afterwards, the layer thickness, B₁, where B₁≠B₂≠B₃≠B₄, will thus be determined, so that the outer diameter of the first corrugation layer, corresponding to the interfacial surface separating the first corrugation layer from the second corrugation layer, will thus be provided by analytical expression using stated constants of this present alternative embodiment. This outer diameter of the first corrugation layer is utilized to calculate the angles and thickness of the second corrugation layer, thereby specifying, the diameter of the second interfacial surface, defining the outer diameter of the second corrugation layer, and so on, wherein it will result that each layer's dimensions are represented as a function of the underlying layer's dimensions. While one skilled in the practice of geometric analysis can readily perform such geometric analysis, it is not preferred, since, it is viewed as, under typical circumstances, an unnecessary and inefficient process; and, also, it is preferred that the structure be generated instead in the preferred 3D CAD software for the purpose of optimization by a finite element analysis (FEA) program, where the range of angles required by this approach can thus be optimized for desired mechanical properties. Thus, it is instead preferred that the stated preferred method be used, which is to use commercially available and commonplace, 3D modeling software, as it is designed to be utilized by those of normal skill in the art.

Whereas the present disclosure has, up to the present point, primarily addressed improved means for forming the embodied frustum core structures (142) that are preferably utilized in the embodied concentration structure (80), particular means for constructing the cladding layers, specifically the reflective inner layer (161) and external layer (162) are also provided, in conjunction with FIGS. 11(b-d). It is found that rigidity, precision, and economy are simultaneously provided by specific structural embodiments that incorporate specific seam structures and segmentation strategies.

Specifically, the embodied reflective layer (161) is preferred to incorporate a segmentation based upon five identical segments, which, after interconnection forming into the desired conical reflector of the embodied conical concentrator (80), the five interconnected segments comprise each seventy-two degrees (72°) segments of the embodied 360-degree conical surface, in FIG. 11(c). In this approach, there is a preferred absence of symmetry in the resulting seam pattern, whereas the number of seams are relatively reduced. The 72° segments also allow for relatively little waste in the cutting of the reflective seams from reflective stock (570), in FIG. 11(b), wherein laser-cut outline (571) of segments (78) are preferably laser-cut by similar pulsed fiber lasers utilized in the edge-surface cuts. A similar process is preferably utilized for the external cladding layer (162).

A preferred linear “C-clamp” structure (563) utilized in seam structures in cladding layers of the embodied frustum-shaped concentrator. The embodied linear clamp provides a means for minimizing loss of reflective area do to seaming structure, since the top flat surface of the linear seam structure is also reflective. The seam structure also provides a relatively continuous modulus in the strained direction of the segmented reflective layer and segmented external layer.

The seam structure (79) may comprise any conventional and appropriate means utilized in sheet metal and similar flexible media for joining two segments of such sheet media so as to form a roughly continuous sheet, including use of various organic adhesives, seam constructions, thermoset resins, thermoplastics, spot welding, diffusion bonding, brazing, soldering, etc. However, in the present invention, specific seam construction is embodied for relatively fast, reliable construction that enables minimal obstruction of reflective surface area, in FIG. 11(d). In particular, a pressed seam structure of the preferred embodiments comprises a separate linear C-clamp structure (563) that preferably has a roughly flat cross-sectional top surface that is highly reflective to solar radiation. An additional objective of the linear C-clamp structure is to provide a seam structure that does not create a discontinuity in the mechanical modulus of the reflective material, specifically in the direction of the central axis in which segments (78) of the reflective layer (161) the reflective layer (161) is curved into the desired conical reflective surface. Accordingly, it is preferred that the linear C-clamp structure is constructed to include a bridging segment, such that the seam is bridged by a bridging segment (569) that has similar mechanical properties as the interconnected segments (78) of the reflective layer, and more preferably is constructed from the same material as the segments (78). Preferably the clamp is slid onto pre-formed bends in the reflector segments so as to join mutually opposed U sections, after which the clamp assembly is preferably pressed, with applied resin, such that the pressing means imparts the same curvature to the seam as that of the desired conical reflector.

A bent parallel feature (565) of seamed edge of reflective layer segment (78) is formed, wherein bent back edges (566) interlock with the linear C-clamp structure. Seamed so as to be bent-back and parallel, seam features (566) of linear C-clamp interlocks opposed seamed edges (567) of the joined reflective layer segments (78), disposed so as to be interlocked by the C-clamp structure. A recess feature (564) is accordingly formed by linear clamp wherein resin is disposed. A reflective surface (110) is preferably also disposed on the C-clamp structure of the seam structure. Any appropriate seaming structure of the sheet metal art may alternatively be utilized in such embodiments utilizing metal cladding layers.

It is not intended that the core material of the disclosed hollow-core frustums be limited to media of the preferred embodiments, as any appropriate material may be substituted by those skilled in the art. The preferred core material provides adequate rigidity, strength, and lightness of a structured framework, such that the core is predominantly open space; accordingly, any core material having such embodied properties may be utilized, including core materials with either ordered or disordered structures. In the preferred embodiment where the core material includes a corrugated thin sheet metal, such corrugation may exist in any suitable aspect, orientation, or format.

It is also not intended that there be any restriction on scaling of the inventive concentrator structure, since it may readily be fabricated in smaller or larger sizes than those contemplated herein. For example, miniature versions of the inventive concentrator structure and manufacturing means may be implemented for construction of solar panels incorporating a plurality of such concentrators in a periodic array for irradiating a corresponding number of individual receiver modules in accordance with the preferred embodiments.

It is also not intended that the disclosed conical frustum structure and methods be limited in its application in any way, as any means for collecting solar energy may benefit from appropriate combination with the embodied concentrator. The structure and method disclosed may also find application in various architectural, aerospace, and other structural applications. Like parts correspond to like parts in different embodiments. Reference throughout this specification to “one embodiment” or “an embodiment” means that a particular feature, structure, process, block, or characteristic described in connection with the embodiment is included in at least one embodiment of the present invention. Thus, the appearances of the phrases “in the present embodiment” or “in another embodiment” in various places throughout this specification are not necessarily all referring to the same embodiment. Furthermore, the particular features, structures, or characteristics may be combined in any suitable manner in one or more embodiments.

Although the present invention has been described in detail with reference to the embodiments shown in the drawing, it is not intended that the invention be restricted to such embodiments. It will be apparent to one practiced in the art that various departures from the foregoing description and drawings may be made without departure from the scope or spirit of the invention.

1. A radiation-concentrating optical element having a conical aspect, comprising:
a.) a first frustum-shaped conical structure;
b.) a second frustum-shaped conical structure disposed in concentric relation to the first structure; and,
c.) corrugated layers disposed in a space defined between the first structure and second structure, such that the corrugated layers form a radial symmetry.

2. A heat-concentrating optical element, comprising:
a.) at least two frustum-shaped concentration structures possessing separate angles of conical aspect, wherein at least one of the frustum shaped concentration structures comprises a hollow-core structure, the hollow-core structure comprising corrugated layers disposed in a space defined between two conical layers, such that the corrugated layers form a radial symmetry having a repeating angular period; and,
b.) means for securing the two concentration structures in a mutually concentric orientation

3. A process for forming a conical structure, comprising the steps:
a.) pre-patterning a layer stock material so as to form an array of cuts;
b.) corrugating the layer material;
c.) forming a cylindrical preform comprising layers of the layer material; and,
d.) separating the preform into a plurality of conical structures.
